(19) United States
(12) Patent Application Publication
(10) Pub. No.: US 2006/0013505 A1
(43) Pub. Date: Jan. 19, 2006

(54) Analysis of geometric surfaces by comformal structure

(76) Inventors: Shing-Tung Yau, Lexington, MA (US); Xiangfeng Gu, Coram, NY (US); Yalin Wang, Los Angeles, CA (US)

Correspondence Address: INTELLECTUAL PROPERTY SOLUTIONS, INCORPORATED, 5717 COLFAX AVENUE, ALEXANDRIA, VA, 22311, US

(21) Appl. No.: 10/534,035

(22) PCT Filed: Nov. 6, 2003
(86) PCT No.: PCT/US03/35395

§ 371 Date: May 6, 2005

Related U.S. Application Data
(60) Provisional application No. 60/424,141, filed on Nov. 6, 2002.

(51) Int. Cl. G06K 9/36

(52) U.S. Cl. 382/285

(57) ABSTRACT

A method for analyzing, classifying, and recognizing geometric surfaces is disclosed. Geometric surfaces are treated as Riemann manifolds and the conformal structure corresponding to the surfaces is calculated. The conformal structure of the surface contains the intrinsic geometric information about the surface, but in a much more compact format as compared to other representations. Conformally mapping the surface to a canonical parameter domain, such as a disk, sphere, or plane retains the geometric information of the surface, and renders the calculation of conformal structure much easier. Various applications enabled by such a conformal representation include surface matching, surface cataloging, surface recognition, animation and morphing between surfaces, and other mathematical analysis.

### CROSS REFERENCE TO RELATED APPLICATIONS

This application claims priority under 35 U.S.C. §119(e) to Provisional Patent Application Ser. No. 60/424,141 filed Nov. 6, 2002; the disclosure of which is incorporated by reference herein.

### STATEMENT REGARDING FEDERALLY SPONSORED RESEARCH OR DEVELOPMENT

N/A

### BACKGROUND OF THE INVENTION

This application is directed to the analysis of surfaces and in particular to the analysis of surfaces by calculating the conformal structure of the surface by providing a fundamental geometric tool for the analysis of surfaces by converting compact Riemann surface theory to computational algorithms.

Geometric surface classification and identification are fundamental problems in the computer graphics and computer aided design fields. As scanning and imaging technology has developed, large numbers of colored meshes are becoming available in databases and on the world wide web (WWW) and the Internet. In addition, medical imaging technology, such as MRI and PET imaging systems are capable of producing three-dimensional (3-D) models of internal body structures. For example, recent developments in brain imaging have accelerated the collection and storage of such images in databases of brain maps. Similarly, in biometric security applications, face recognition involves the imaging, storing, and matching of 3-D facial features to previously stored faces. Also, entertainment systems that use 3-D webpages are increasing in number, and computer animation techniques, such as morphing and texture mapping, also involve the creation and manipulation of 3-D surfaces.

In all of these applications, the geometric data are represented as triangular meshes that have a combinatorial structure instead of a differential structure. Accordingly, it is difficult to process these surfaces using differential geometry techniques. Current analysis methods measure the Hausdorff distance between two surfaces; however, there is no general approach to find correspondence between the surfaces and in addition, combinatorial searching is inefficient. In addition, the current methods of surface analysis are heavily dependent upon the triangulation and resolution of the surface. However, different triangulations and resolutions can result in widely varying results. Finally, geometric surface data are extremely large. One surface can have millions of vertices and faces such that the sheer number of calculations that are needed for current systems make it extremely difficult to develop effective and efficient algorithms. In addition, currently there is no effective general method to classify surfaces using topological invariants since the classification is typically too coarse, or using Euclidean geometric invariants since the classification is too rigid.

Accordingly, it would be useful to provide a geometric analysis method that is an intrinsic system in that it depends only upon the geometry of the surface; that provides for a general way to classify surfaces effectively, find correspondence between two surfaces in the same class; and that provides for efficient and achievable computation that is both numerically stable and accurate.

### BRIEF SUMMARY OF THE INVENTION

A method for analyzing, classifying, and recognizing geometric surfaces is disclosed. Geometric surfaces are treated as Riemann manifolds and the conformal structure corresponding to the surfaces is calculated. The conformal structure of the surface contains the intrinsic geometric information about the surface, but in a much more compact format. In general however, surfaces are represented as a plurality of mesh data, with the number of mesh data points being quite large. Calculating the conformal structure of such a meshed surface can be a difficult undertaking due to the large number of mesh data points and the even larger number of calculations that are required. Conformally mapping the surface to a canonical parameter domain, such as a disk, sphere, or plane retains the geometric information of the surface, and renders the calculation of conformal structure much easier.

In particular, in one embodiment, first and second surfaces are conformally mapped to a canonical parameter domain forming first and second mapped surfaces. The conformal parameterization for each mapped surface are computed and compared with one another to determine if the surfaces match.

In another embodiment, a method for classifying a surface is disclosed in which the surface is classified according to the conformal parameterization. In particular, the period matrix R corresponding to the surface is determined and stored. Subsequently, a search for a particular surface can be conducted by examining the previously stored period matrix R and comparing this matrix to a second period matrix R′ that corresponds to a desired surface.

In another embodiment, a method for surface recognition is provided. In particular, a mesh representing a surface is provided and one or more feature points are sequentially removed. For each feature point that is removed the corresponding period matrix R is calculated. By comparing the resulting sequence of period matrices to previously calculated sequences of period matrices, a surface may be recognized.

Alternatively, all feature points can be removed at once and a point is selected within the surface. As this point is moved about the surface on a predetermined orbit, a sequence of period matrices are calculated and compared to a previously calculated sequence of period matrices.

In another embodiment, a method of image compression is disclosed. A mesh representing a surface is provided and the conformal parameterization for the mesh is calculated. Using the conformal parameterization, the mean curvature can be calculated and with these two parameters, the original surface can be uniquely determined.

In another embodiment, applications to medical imaging are disclosed. A medical image, such as of the brain or other organ is typically a genus-zero surface. Conformally mapping the genus-zero surface to a sphere enables the surface to be analyzed.

In another embodiment, a method for animating a surface is disclosed. Given two similar shapes the feature points are removed from each surface and the doubling of each surface is computed. Each surface is decomposed to one or more patches and each patch is mapped to a plane. A conformal mapping from one plane to another is determined and after selecting control points, and a BSpline or other smooth curve function is used to generate a smooth transition between the two planes.

In another embodiment, a method for generating textures to cover a given surface is provided. The surface is mapped using conformal parameterization to a canonical parameter surface, such as a plane surface, and the texture calculated for that parameter surface. To make the texture patches globally smooth, the Dirichlete method is used to diffuse the boundaries between texture patches. In this way, the texture patches are “grown” and “stitched” together and then mapped to the parameter surface.

Other forms, features, and aspects of the above-described methods and system are described in the detailed description that follows.

### BRIEF DESCRIPTION OF THE SEVERAL VIEWS OF THE DRAWINGS

The invention will be more fully understood from the following detailed description taken in conjunction with the accompanying drawings in which:

FIGS. 1a and 1b depict a conformal mapping between a human face and a square;

FIGS. 1c and 1d depict a checker board texture mapped from the human face of FIG. 1a to the plane of FIG. 1b;

FIGS. 2a-d depict various components of a holomorphic 1-form of a two hole torus;

FIG. 3 is a spherical conformal embedding of a gargoyle model in a sphere;

FIG. 4 depicts a human brain model conformally mapped to a sphere;

FIG. 5 depicts a bunny model mapped to the unit sphere;

FIGS. 6a-b depict zero points of parameterization;

FIGS. 7a-d depict a global conformal atlas for genus two and three tori;

FIGS. 8a-d depict the topological equivalence but not conformal equivalence of two genus-one tori;

FIGS. 9a-d depict genus-one surfaces with different conformal structures;

FIGS. 10a-d depict the improvement in uniformity of the global conformal parameterization;

FIGS. 11a-d depict various genus-two surfaces with different conformal structures;

FIGS. 12a-b depict the use of regulariztion of the triangulation of a bunny surface;

FIGS. 12c-d depict a reconstruction of the bunny surface from a conformal geometric image;

FIG. 13a depicts a brain surface model;

FIG. 13b depicts the brain surface model of FIG. 13a conformally mapped to a sphere;

FIG. 13c depicts a spherical geometry image of the brain surface model of FIG. 13a;

FIG. 13d depicts a brain surface model reconstructed after FIG. 13c has been compressed 256 times;

FIG. 14 depicts a geometric morphing from a human female face to a human male face using conformal structures;

FIGS. 15a-b depict the global parameterization of a tea pot model at an original level of triangulation;

FIGS. 15c-d depict the global parameterization of a tea pot model at a simplified level of triangulation; and

FIGS. 16a-d depict the global parameterization results for four high genus surfaces.

### DETAILED DESCRIPTION OF THE INVENTION

In the embodiments that follow, two-dimensional (2-D) surfaces are treated as Riemannan surfacesand the conformal structure corresponding to the surfaces is calculated. All orientable surfaces are Riemann surfaces, and have an intrinsic conformal structure that is invariant under conformal transformations. In general, the conformal structure is more refined than a topological structure and less rigid than a metric structure. For a genus-one surface, the space of all the conformal structure is two-dimensional. Thus, by using two parameters, all genus-one surfaces can be classified. In general, for a genus g surface, the space of all the possible conformal structure is 6g-6 dimensional. Thus, all genus g surfaces can be classified using a g by g complex matrix.

A methodology is provided to systematically compute the conformal equivalence between two surfaces is provided. In particular, for any two surfaces that have the same conformal structure, a method is provided to systematically compute the conformal one-to-one mapping between the two surfaces. For a genus-zero surface, the group of such mapping is 6-dimensional. For a genus-one surfaces, such a group is two-dimensional. For surfaces of more than genus-one, such a group of such mapping includes only one dimension. Thus, advantageously, the methods described below provide an efficient method to find the best mapping and measure the Hausdorff distance between any two surfaces with the same conformal structure.

For the methods described below in which the conformal structure of a surface is determined, the conformal structure is only a function of the geometry of the surface. It is unaffected by either triangulations and resolution and in addition, conformal mapping preserves the shape of the surface.

It is well known that all surfaces are Riemann surfaces. Any Riemann surface has a conformal coordinate atlas, or a conformal structure. A conformal transformation maps a conformal structure to a conformal structure. Angles are preserved everywhere by a conformal transformation between two Riemann surfaces. As is known, a one-dimensional connected complex manifold is known as a Riemann surface. By Riemann uniformication theorem, all surfaces can be globally conformally embedded in a canonical space. The canonical space is typically a disk, a plane, or a sphere, the choice being determined by the intrinsic geometry of the surface. The conformally embedded surface includes a large portion of the original geometric information embedded onto the canonical spaces. Through conformal embedding, 3D surface matching problems can be converted to 2D matching problems in these 3 canonical spaces. As discussed in more detail below, this method has the potential for non-rigid, deformed surface matching.

The way of embedding the surface to the canonical space reflects the conformal structure of the surface. Specifically, all the global conformal embedding from a surface to the canonical space form a special group. If two surfaces can be conformally mapped to each other, they share the same group structure. In other words, such group structures are the complete conformal invariants. Hence, we can classify all surfaces using conformal invariants. For each topologically equivalent class, there are an infinite number of conformal equivalent classes. This is valuable for surface classification problems.

Let S₁ and S₂ be two regular surfaces, parameterized by (x₁, x²). Define a map φ: S₁→S₂ represented in the local coordinates as φ(x¹, x²)=(φ¹(x¹, x²), φ(x¹, x²)).

Let the first fundamental forms (Riemann metrics) of S₁ and S₂ be:

$$\begin{matrix}{ds}_{1}^{2} = {\sum }_{ij} {g}_{ij} {dx}^{i} {dx}^{j} & ( 1 ) \\ {ds}_{2}^{2} = {\sum }_{ij} {\tilde{g}}_{ij} {dx}^{i} {dx}^{j} . & ( 2 )\end{matrix}$$

The pull back metric on S₁ induced by φ is

$${ϕ}^{*} {ds}_{2}^{2} = {\sum }_{mn} {\sum }_{ij} {\tilde{g}}_{ij} \frac{\partial {ϕ}^{i}}{\partial {x}^{m}} \frac{\partial {ϕ}^{j}}{\partial {x}^{n}} {dx}^{m} {dx}^{n} . \qquad ( 3 )$$

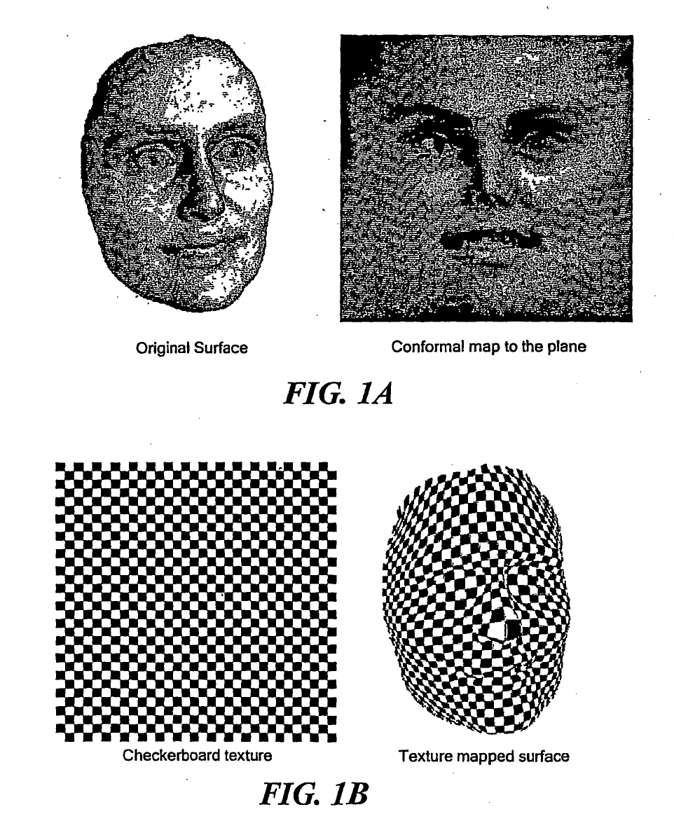

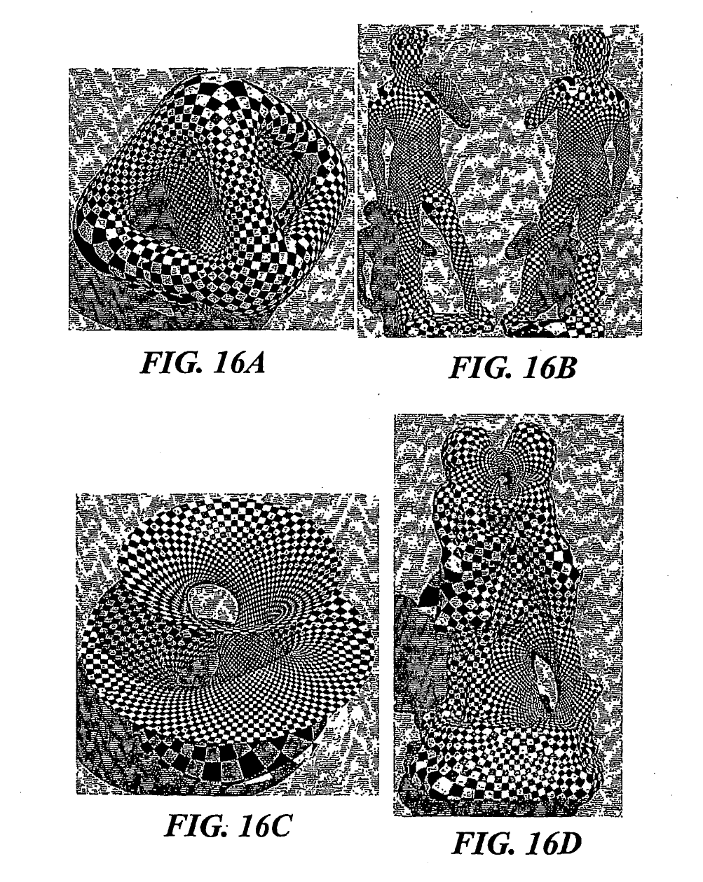

If there exists a function λ(x¹,x²), such that
ds₁²=λ(x¹,x²)φ*ds₂², (4)
then we say that φ is a conformal map between S₁ and S₂. In particular, if the map from S₁ to the local coordinate plane (x₁, x₂) is conformal, then (x₁, x₂) is a conformal coordinate of S₁, which is also referred to as an isothermal coordinate. FIG. 1a depicts a conformal mapping between a human face and a square on the plane. FIG. 1b depicts the conformal nature of the mapping by texture mapping a checkerboard to the surfaces. Inspection of FIGS. 1a and 1b illustrates that all right angles on the checkerboard are preserved on the texture of the surface. FIG. 16 depicts the global parameterization results of four surfaces having a high genus, i.e., a surface with a genus >1. As can be seen, all angles on the checkerboard pattern are right angles, indicative of the conformal nature of the mapping.

For a complex manifold, suppose U⊂C is an open set and let f be a complex function ƒ:U→C. Then f is said to be holomoophic, if for any z₀∈U there exists an ε>0 such that on the disk
D(z₀,ε)={z∈C∥z−z₀∥<ε}, (5)
then f can be represented as a convergent power series

$$f ( z ) = {\sum }_{i \geq 0} {{a}_{i} ( z - {z}_{0} )}^{i} . \qquad ( 6 )$$

Let U⊂C and V⊂C be open sets of C. A map ƒ:U→V is biholomorphic if f is one-to-one and holomorphic and ƒ⁻¹:V→U is also holomorphic.

Let S be a connected Hausdorff space with a family {(Uⱼ,zⱼ)}ⱼ_{^{εJ}} that satisfies the following three conditions:

1. Every Uⱼ is an open subset of S, and S=∪ⱼ_{^{εJ}}Uⱼ.

2. Every zⱼ is a homeomorphism of Uⱼ onto an open subset Dⱼ in the complex plane.

3. If Uⱼ∩Jₖ≠φ, the transition mapping
zₖⱼ=zₖⱼ∘zⱼ⁻¹:zⱼ(Uⱼ∩Uₖ)→zₖ(Uⱼ∩Uₖ) (7)
is a biholomorphic mapping, which is also a holomorphic homeomorphism.

Thus, {(Uⱼ,zⱼ)}ⱼ_{^{εJ}} is a system of coordinate neighborhoods on S and defines a one-dimensional complex structure on S. The coordinate neighborhood (U,z) of a Riemann surface is a pair of an open set U in S and a homeomorphism z of U into the complex plane. U is referred to as a coordinate neighborhood of S and the homeomorphism z is referred to as a local coordinate or a local parameter.

In general, a mapping f of S onto a Riemann surface R is said to be a holomorphic mapping, if w∘ƒ∘z⁻¹ is holomorphic for all coordinate neighborhoods (U,z) of S′ and (V,w) of R with ƒ(U)⊂V. A biholomorphic mapping ƒ:S→R means that a holomorphic mapping f of S onto R has the holomorphic inverse mapping ƒ⁻¹:R→S.

Thus, two Riemann surfaces S and R are biholomorphic equivalent if there exists a biholomorphic mapping between them. If such a mapping exists, then S and R are regarded as the same Riemann surface and S and R have the same conformal structure. In general, complex structure, biholomorphic mappings and biholomorphic equivalence are also said to be conformal structures, conformal mappings and conformal equivalence, respectively.

Let a surface S have a Riemann metric equal to

$${ds}^{2} = {\sum }_{ij} {g}_{ij} {dx}^{i} {dx}^{j} ,$$

then the metric can be used to uniquely determine a conformal structure {(Uᵢ,zᵢ)), such that the local representation of ds² on a coordinate neighborhood (Uᵢ,zᵢ) is
ds²=λ(zᵢ)dzᵢd\overline{z}ᵢ, (8)
where λ(zᵢ) is a positive real function.

To compute the conformal structure all the holomorphic differential forms on S must be found. Let S be a Riemann surface, then a holomorphic differential form ω on S is given by a family of {(Uᵢ,zᵢ,ωᵢ)} that satisfies the following two conditions:

1. Suppose {Uᵢ,zᵢ)} is a conformal structure, then ω has local representation ωᵢ such that
ωᵢ=ƒᵢ(zᵢ)dzᵢ (9)
where fᵢ is a holomorphic function on Uᵢ.

2. If zᵢ=φᵢⱼ(zⱼ) is a coordinate transition on Uᵢ∩Uⱼ≠φ then

$${f}_{i} ( {ϕ}_{ij} ( {z}_{j} ) ) \frac{ⅆ {ϕ}_{ij} ( {z}_{j} )}{ⅆ {z}_{j}} = {f}_{j} ( {z}_{j} ) . \qquad ( 10 )$$

Thus, the local representation satisfies the chain rule
ƒᵢ(zᵢ)dzᵢ=ƒⱼ(zⱼ)dzⱼ. (11)

The set of all holomorphic differentials on S is denoted as Ω¹(S), where Ω¹(S) has a group structure that is isomorphic to the cohomology group of S. Thus, to compute Ω¹(S) the homology group of S must be computed.

Let S be a two-dimensional Riemann manifold with metric g, N⊂R³ a compact two-dimensional manifold. For a C¹ map φ=(φ¹,φ²,φ³):S→N⊂R³, let

$$e ( ϕ ) = {\sum }_{i , α , β} \frac{1}{2} {g}^{αβ} ( x ) \frac{\partial {ϕ}^{i}}{\partial {x}^{α}} \frac{\partial {ϕ}^{i}}{\partial {x}^{β}} = \frac{1}{2} {\vert ∇ ϕ \vert}_{S}^{2} \qquad ( 12 )$$

be the energy density in local coordinates x=(x¹,x²) on S, g=(g,p (g_{αβ}),(g^{αβ})=(g_{αβ})⁻¹. A C¹ variation of φ is a family (φ_{ε}) of C¹ map φ_{ε}:S→N smoothly depending on a parameter |ε|<ε₀, and such that φ₀=φ. A variation (φ_{ε}) of φ is compactly supported if there exists a compact set Ω⊂S such that φ_{ε}=φ on S/ω on all |ε|<ε₀.

A harmonic map on C¹ is a map φ:S→N⊂R³ that is stationary for Dirichlet's energy with respect to compactly supported variations and is given by

$$E ( ϕ ) = {\int }_{S} e ( ϕ ) ⅆ {A}_{S} . \qquad ( 13 )$$

In local coordinates dAₛ=\sqrt{|g|}dx¹dx², where |g|=det(g_{αβ}). A map φ is harmonic if and only if
Δ_{Sφ}=λn∘, (14)
where λ is a function globally defined on S and n∘φ is the normal at the image point on N. For a genus-zero surface, a harmonic mapping is a conformal mapping. If N is R then φ is called a harmonic function. Note that all conformal maps are harmonic, but not all harmonic maps are conformal.

A real differential 1-form τ on S is harmonic if for any point on S, there exists an-open set D⊂S, such that
τ|_{D}=dƒ|_{D}, (15)
where f is a harmonic function on S and d is the exterior-differential operator.

All harmonic differentials form a special group H that is isomorphic to the cohomology group H¹(S,R). According to Hodge theory, in each cohomology class, there is a unique harmonic differential form.

A holomorphic 1-form ω can be decomposed into two real differential 1-forms τ and γ, such that ω=τ+\sqrt{−1}γ, and in which both τ and γ are harmonic. By integrating a holomorphic 1-form on the surface, the surface can be conformally mapped to the complex plane.

All holomorphic 1-forms form a group Ω¹(S) that is the dual to the homology group H₁(S,Z). For a genus g surface S, there are 2 g generators of H₁(S,Z). Corresponding to each handle, there are two generators γᵢ,γ_{i+g} such that
γᵢ·γ_{i+g}=δᵢ^{j},i,j=1,2, . . . , g, (16)
where · represents the algebraic intersection number of two closed curves. Then {γ₁,γ₂, . . . γ_{2g-1},γ_{2g}} is called the canonical homology basis. If B={γ₁,γ₂, . . . γ_{2g-1},γ_{2g}} is a basis of H₁(S,Z), the dual holomorphic 1-form basis is B*={ω₁, ω₂ . . . ,ω_{2g-1},ω_{2g}}, satisfying

$$Re {\int }_{{γ}_{i}} {ω}_{j} = - {r}_{i} \cdot {r}_{j} . \qquad ( 17 )$$

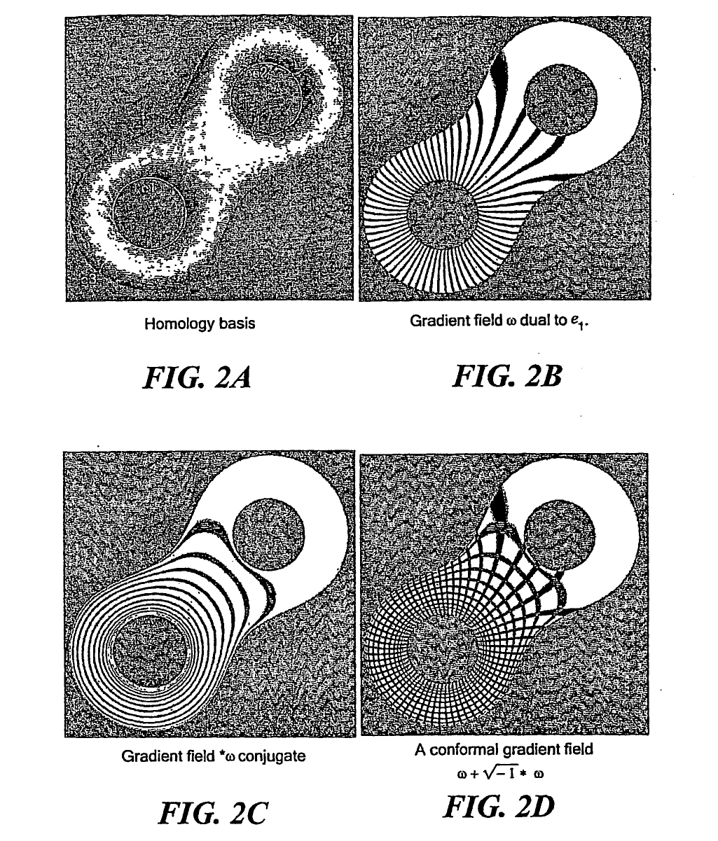

FIGS. 2a-2d depict the homology basis of a two-hole torus in FIG. 2a which consists of four closed curves. FIG. 2b depicts the harmonic 1-form ω dual to e₁ in which the shaded curves are the integration lines of ω. FIG. 2c depicts the conjugate harmonic 1-form ω^{★} that is orthogonal to harmonic 1-form depicted in FIG. 2b. FIG. 2d depicts the holomorphic 1-form ω+\sqrt{−1}ω*.

The complete invariant for conformal equivalence is provided by a complex matrix. Suppose B=γ,γ₂ . . . , γ_{2g}} is a canonical homology basis and B*={ω₁,ω₂ . . . ,ω_{2g-1},ω_{2g}} is a basis of Ω¹(S), then the matrix P=(pᵢⱼ) is called the period matrix of S, where

$${p}_{ij} = {\int }_{{γ}_{i}} {ω}_{j} . \qquad ( 18 )$$

Examination of the period matrices of two surfaces, given by P₁ and P₂, respectively, can determine whether the two surfaces are conformally equivalent to one another, without the need to compute the conformal mappings between the two surfaces.

In general, surfaces are represented by triangular meshes. Every simplicial surface has a natural underlying complex structure. Let K be a simplicial complex, and a mapping ƒ:|K|→R³ embeds |K| in R³, then M=(K,f) is called a triangular mesh, and Kₙ where n=0,1,2 are the sets of n-simplicies. σⁿ denotes the n-simplex, σⁿ={υ₁,υ₂, . . . σₙ}, where υᵢ∈K₀.

A chain space is the linear combination of simplicies and is given by

$${C}_{n} ( M ) = \{ {\sum }_{j} {c}_{j} {σ}_{j}^{n} \vert {c}_{i} ∈ Z , {σ}_{j}^{n} ∈ {K}_{n} \} . \qquad ( 19 )$$

The elements in Cₙ, n=0,1,2 are called an n-chain. Also, the summation of all faces Σₖƒₖ is in C₂ and M is also used to denote this 2-chain.

A boundary operator ∂ₙ:Cₙ→Cₙ₋₁ among chain spaces is a linear operator. Let σ∈Kₙ,σ=[υ₀,υ₁, . . . , υₙ₋₁], then

$${\partial }_{n} {σ}^{n} = {\sum }_{i = 0}^{n - 1} {( - 1 )}^{i} [ {υ}_{0} , … , {υ}_{i - 1} , {υ}_{i + 1} , … {υ}_{n - 1} ] . \qquad ( 20 )$$

Then for an n-chain in Cₙ, the boundary operator is defined as
∂ₙΣcᵢσᵢⁿ=Σcᵢ∂ₙσhd iⁿ. (21)

To denote the null space of ∂₁, ker∂₁⊂C₁ represents all the closed loops on M. Similarly, img∂₂⊂C₁ represents the image space of ∂₂ representing all the surface patch boundaries. Since ∂₁·∂₂=0, then img∂₂ ⊂ ker∂₁. Hence, the homolgy group of M, Hₙ(M,Z) is given as

$${H}_{n} ( M , Z ) = \frac{ker {\partial }_{n}}{img {\partial }_{n + 1}} . \qquad ( 23 )$$

H₁(M,Z) represents all the closed loops that are not the boundaries of any surface patch on M. The topology of M is determined by H₁(M,Z).

Let M be a closed mesh of genus g, and B={γ₁,γ₂, . . . , γ_{2g}} be an arbitrary basis of its homology group. Then the intersection matrix C of B is given by
cᵢⱼ=−γᵢγⱼ (24)
where the · denotes the number of intersections, counting +1 when the direction of the cross product of the tangent vectors of eᵢ and eⱼ at the intersectin point is consistent with the normal direction and −1 otherwise.

A co-chain space is the set of homeomorphisms between chain spaces to R and are given by
Cⁿ(M)=Hom(Cₙ,R),n=0,1,2 (25)
where Hom(Cₙ, R) represents the set of all homeomorphisms between Cₙ to R. The elements of Cₙ are called n-cochains or n-forms. A coboundary operator is defined as δₙ:Cⁿ→Cⁿ⁺¹. Let ωₙ∈Cⁿ be an n-form and cₙ₊₁∈ Cₙ₊₁ is an n+1 chain, then
(δₙωₙ)(cₙ₊₁)=ωₙ(∂ₙ₊₁cₙ₊₁), (26)
and δ₁·δ₀=0.

The cohomology group Hⁿ(M, R) is defined as

$${H}^{n} ( M , R ) = \frac{ker {\partial }_{n}}{img {\partial }_{n - 1}} . \qquad ( 27 )$$

1-forms in kerδ¹ are called closed 1-forms and 1-forms in imgδ⁰ are called exact 1-forms. Two closed 1-forms are called cohomologous if they differ by an exact 1-form. Cohomology group H¹(M,R) is isomorphic to homology group H₁(M,Z).

Integration of an n-form along an n-chain is defined when cₙ∈Cₙ and ωₙ∈Cⁿ, as
<ωₙ,cₙ>=ωₙ(cₙ). (28)
The boundary and coboundary operators are related by the Stokes formulae
<ωₖ₋₁,∂ₖcₖ>=<δ^{k+1}ωₖ₋₁,cₖ> (29)

A Wedge product is a bilinear operator ˆ:C¹×C¹→C⁰. Let f∈K₂ be a face on M, ∂₂f=e₀+e₁+e₂, ω, τ∈C¹ then

$$ω ⋀ τ ( f ) = \frac{1}{6} \vert \begin{matrix}ω ( {e}_{0} ) & ω ( {e}_{1} ) & ω ( {e}_{2} ) \\ τ ( {e}_{0} ) & τ ( {e}_{1} ) & τ ( {e}_{2} ) \\ 1 & 1 & 1\end{matrix} \vert . \qquad ( 30 )$$

A bilinear operator star wedge product ˆ*:C¹×C¹→C² is defined similarly. Let f∈K₂, the lengths of three edges as l₀, l₁, l₂, and the area of f as A, then
ωˆ*γ(ƒ)=ΩGΓ^{t}, (31)
where
Ω=(ω(e₀),ω(e₁),ω(e₂)) (32)
Γ=(γ(e₀ ),γ(e₁),γ(e₂ )) (33)
and the quadratic form G has the form

$$\frac{1}{{24}_{S}} ( \begin{matrix}- 4 {l}_{0}^{2} & {l}_{0}^{2} + {l}_{1}^{2} - {l}_{2}^{2} & {l}_{0}^{2} + {l}_{2}^{2} - {l}_{1}^{2} \\ {l}_{1}^{2} + {l}_{0}^{2} - {l}_{2}^{2} & - 4 {l}_{2}^{2} & {l}_{1}^{2} + {l}_{2}^{2} - {l}_{0}^{2} \\ {l}_{2}^{2} + {l}_{0}^{2} - {l}_{1}^{2} & {l}_{2}^{2} + {l}_{1}^{2} - {l}_{0}^{2} & - 4 {l}_{2}^{2}\end{matrix} ) . \qquad ( 34 )$$

The harmonic energy ω of a closed 1-form is given by

$$\begin{matrix}E ( ω ) = {\sum }_{e ∈ {K}_{1}} {w}_{e} {ω ( e )}^{2} , \\ where & ( 35 ) \\ {w}_{e} = \frac{1}{2} ( cot α + cot β ) & ( 36 )\end{matrix}$$

and if e is a boundary edge, e∈∂₂M, then e attaches to one face f₀ and then wₑ is given by

$${w}_{e} = \frac{1}{2} cot α . \qquad ( 37 )$$

A closed 1-form is called a harmonic 1-form if it minimizes the harmonic energy, that is if the Laplacian operator defined as

$$Δω ( u ) = {\sum }_{[ u , v ] ∈ {K}_{1}} {w}_{[ u , v ]} ω ( [ u , v ] ) \qquad ( 38 )$$

is equal to zero. Thus, a closed 1-form is harmonic if and only if its Laplacian is zero. Let M have a homology basis {r₁,r₂, . . . , r_{2g}} and a harmonic 1-form basis {ω₁,ω₂, . . . ω_{2g}}, if
<rᵢ,ωⱼ>=γᵢ·γⱼ,i,j=1,2, . . . , 2g (39)
where −γᵢ·γⱼ is the algebraic intersection number of γᵢ and γⱼ then the homology basis and harmonic 1-form basis are said to be dual to each other.

Let M be a mesh and N is a smooth surface in R³. A piecewise linear map u:M→N⊂R³ maps all the vertices of M to N as
u(K₀)⊂N. (40)
The harmonic energy of u=(u¹, u², u³) is given as

$$E ( u ) = {\sum }_{α} E ( δ {u}_{α} ) \qquad ( 41 )$$

where E(δu_{α}) is the harmonic energy defined for the 1-form (δu_{α}). If u minimizes the harmonic energy, E(u), then u is a harmonic map and satisfies the following condition
Δu=(Δδu¹,Δδu²,Δδu³)=λn∘u, (42)
where n is the normal field on N.

Given a harmonic 1-form ω, there is a unique conjugate harmonic 1-form ω*. A holomorophic 1-form is defined as
ω+\sqrt{−1}ω*. (43)
All holomorphic 1-forms form a group Ω¹(M) that is isomorphic to H¹(M,R). The basis of Ω¹(M) can be constructed directly from a basis of the harmonic 1-form group. Given a harmonic 1-form group having a basis of {ω₁,ω₂, . . . ω_{2g}}, then the basis of Ω¹(M) is given by {ω₁+\sqrt{−1}ω*₁,ω₂+\sqrt{−1}ω*₂, . . . ,ω_{2g}+\sqrt{−1ω}*_{2g}}.

Given B={γ₁,γ₂, . . . γ_{2g-1,}γ_{2g}} is a basis of H₁(M,Z), and B*={ω₁,ω₂ . . . ,ω_{2g-1}, ω_{2g}} is the dual basis of Ω¹(M), then a matrix C_{2gx2gx}=(cᵢⱼ) and a matrix S_{2gx2gx}=(sᵢⱼ) are defined as
cᵢⱼ=<γᵢ,ωⱼ> (44)
sᵢⱼ=<γᵢ,ω*ⱼ>. (45)
Then the period matrix R of M is defined as
CR=SI. (46)
Where R satisfies R²=−I. The matrices (C,R) determine the conformal equivalent class of M. In particular, for any two surfaces M₁ and M₂ with (R₁,C₁) and (R₂,C₂), respectively, then M₁ and M₂ are conformal equivalent to one another if and only if there exists an integer matrix N such that
N⁻¹R₁N=R₂;N^{T}C₁N=C₂. (47)

The conformal structure of a mesh of genus g>0 is a family of {(Uᵢ,zᵢ)} such that

1. Uᵢ is simply connected and is formed by the faces of M.

2. M⊂∩Uᵢ.

3. zᵢ is piecewise linear, and there exists a holomorphic 1-form ω such that δzᵢ|uᵢ=ω|uᵢ.

For a genus-zero mesh, there are no holomorphic 1-forms. In this case, the genus-zero surface can be conformally mapped to the surface of the unit sphere S² and the conformal structure of S² can be used to define the conformal structure of M. Thus, a discrete harmonic map u:M→S² defines the conformal structure of M. For any surface, by cutting M along c∈C₁, a topological disk D_{M} can be formed and with it a special 1-chain. This cut along c is referred to as a locus or cut graph, and D_{M} is a fundamental domain of M. The choice of c is not unique and accordingly, neither is the fundamental domain.

A conformal map u:D_{M}→C can be found by using a holomorphic 1-form ω+\sqrt{−1}ω*∈Ω¹(M). A base point υ₀∈D_{M} is selected and for any vertex υ∈D_{M} an arbitrary path γ∈C₁(D_{M}) is chosen, such that ∂₁γ=υ-υ₀, then
u(υ)=<ω,γ>+\sqrt{−1}<ω*,γ> (48)

As discussed above, all genus-zero surfaces can be mapped to a sphere and therefore, all genus-zero surfaces are conformally equivalent. All conformal maps from S² to itself, form a six-dimensional Möbius transformation group. Using stereo-graphic projection to map the sphere to the complex plane, all Möbius transformations are of the form

$$\frac{az + b}{cz + b} , ad - bc = 1 , a , b , c , d ∈ C . \qquad ( 49 )$$

However, to compute a conformal map to map a genus-zero surface to a sphere, extra constraints on the Möbius transformations are needed to make the solution unique due to the form of the Möbius transformations.

Another difficulty is that the image of the map is on S² and not in R³. Accordingly, when the map is updated, the image should be moved in the tangent space of S² and not in R³.

Having established the foregoing, several algorithms are provided below to compute the conformal structure described above. Applications in computer graphics, computer vision, and medical imaging fields are described.

In the algorithm that follows, Algorithm 1, the conformal maps between an arbitrary genus-zero surface and a sphere is calculated. First, the image mass center must be computed and is of the form

$$m c ( ϕ ) = {\int }_{M} ϕ ⅆ {A}_{M} . \qquad ( 50 )$$

For the discrete case, the following approximation may be used

$$m c ( ϕ ) = \frac{{\sum }_{u ∈ {K}_{0}} ϕ ( u ) {\sum }_{[ u , v , w ] ∈ {K}_{2}} {A}_{[ u , v , w ]}}{3 {\sum }_{[ u , v , w ] ∈ {K}_{3}} {A}_{[ u , v , w ]}} \qquad ( 51 )$$

where A_{[u,v,w]} is the area of face [u,v,w].

Algorithm 1 can now be used to compute conformal maps of genus-zero meshes to S².

Algorithm 1: Conformal Parameterization of Genus 0 Meshes

Input: A closed genus-zero mesh M

Output: A global conformal map φ:M→S²

1. Compute the Gauss map, mapping M to S²

2. Compute the Laplacian at each vertex u of M, Δφ(u).

3. Project Δφ(u) to the tangent space of φ(u)∈ S².

4 Update φ(u) along the negative projected Δφ(u).

5. Compute the center of mass of Δφ(u), mc(φ), shift the center of mass to the center of S², renormalize φ(u) to be on S².

6. Repeat steps 2-5 for all vertices, until the projected Laplacian equals zero.

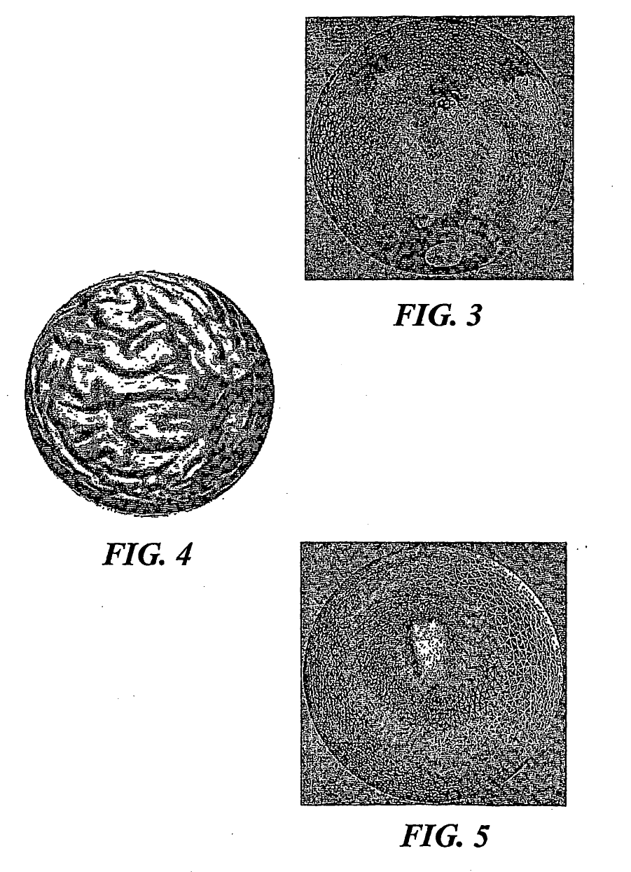

FIGS. 3, 4, and 5 depict spherical conformal mapping for three different genus-zero surfaces. In particular, FIG. 3 depicts a gargoyle model conformally mapped to S², FIG. 4 depicts a brain model conformally mapped to S², and FIG. 5 depicts a bunny model conformally mapped to S².

With regard to computing the conformal maps between any two topological disks, all such mappings form a three-dimensional group that is a subgroup of the Möbius group discussed above and is represented by

$$ϕ ( z ) = \frac{az + b}{\overline{b} z + \overline{a}} , a \overline{a} - b \overline{b} = 1 , a , b ∈ C . \qquad ( 52 )$$

In order to compute the conformal maps between a topological disk and a unit disk, a technique referred to as doubling is used.

Doubling converts surfaces with boundaries to closed symmetric surfaces. Given a surface M with a boundary ∂M, a symmetric closed face \overline{M} is constructed such that \overline{M} covers M twice. That is, there exists an isometric projection π:\overline{M}→M that maps a face \overline{ƒ} ∈ \overline{M} isometrically to a face ƒ ∈ M. For each face ƒ ∈ M there are two preimages in \overline{M}. Algorithm 2 computes the doubling of a general mesh M.

Algorithm 2. Compute Doubling of an Open Mesh

Input: A mesh M with boundaries.

Output: The doubling of M, \overline{M}.

1. Make a copy of M, denoted as −M.

2. Reverse the orientation of −M.

3. For any boundary vertex u ∈ δM, there exists a unique corresponding boundary vertex −u ∈ δ −M, and for any edge on e∈ δM there exists a unique boundary edge −e∈ δ −M. Find all the corresponding vertices and edges.

4. Glue M and −M such that the corresponding vertices and edges are identical. The resulting mesh is the doubling \overline{M}.

Using the doubling technique described in Algorithm 2, the conformal mapping of a topological disk to S² can be directly computed. Since the doubling surface is symmetric, M and −M will be mapped to a separate hemisphere and using stereographic projection π a hemisphere of the sphere can be mapped to the unit disk. In this manner, a conformal mapping is computed that maps between the topological disk and the unit disk D². By applying the Möbius transformation in equation (52), all possible conformal mappings may be computed.

Algorithm 3. Compute a Global Conformal Map from a Topological Disk to D².

Input: A topological disk M.

Output: A global conformal map φ from M to the unit disk D².

1. Compute the doubling \overline{M} of M.

2. Compute a global conformal map φ:\overline{M}→S², preserving symmetry.

3. Rotate φ(\overline{M}) such that φ(∂ M)is the equator.

4. Use stereo-graphic projection π to map the upper hemisphere to the unit disk.

5. Output π°φ.

For surfaces with non-zero genus, the holomorphic 1-form group Ω¹(M), which is determiend by the topology of the surface, is important in computing global conformal parameterization for these surfaces. To compute this group, the homology basis is computed first, the dual harmonic 1-form basis is computed next, and then the harmonic 1-form is converted into a base holomorphic 1-form.

Algebraic algorithms for computing homology and harmonic 1-forms are introduced. Given a mesh M, the corresponding homology basis is computed using an algebraic topology method. Let σᵢⁿ ∈ Kₙ and σₖⁿ⁻¹ ∈ Kₙ₋₁, then define

$$[ {σ}_{i}^{n} , {σ}_{k}^{n - 1} ] = \{ \begin{matrix}+ 1 & + {σ}_{k}^{n - 1} ∈ \partial {σ}_{i}^{n} \\ - 1 & - {σ}_{k}^{n - 1} ∈ \partial {σ}_{i}^{n} \\ 0 & \pm {σ}_{k}^{n - 1} ∉ \partial {σ}_{i}^{n}\end{matrix} \} \qquad ( 53 )$$

Then the n-dimensional boundary matrix is defined as
∂ₙ=([σᵢⁿ,σₖⁿ⁻¹]). (54)
The homology basis is then formed from the eigenvectors corresponding to zero eigenvalues of the following operators
d=∂₁^{T}∂₁+∂₂∂₂^{T}. (55)
Algorithm 4. Computing Homology Basis for Mesh M

Input: Mesh M.

Output: Homology basis {γ₁, γ₂, . . . ,γ_{2g}}.

1. Compute the boundary matrices for ∂₁, ∂₂.

2. Compute the Smith normal form of the matrix D=∂₁^{T}∂₁+∂₂∂₂^{T}.

3. Find the eigenvectors of D corresponding to zero eigenvalues, to form {γ₁,γ₂, . . . ,γ_{2g}}.

All harmonic 1-forms form the cohomology group that is the dual of the homology group H₁(M,Z). A harmonic 1-form is both closed and harmonic. According to Hodge theory all the harmonic 1-forms form a linear space that is the dual space of the homology group. Also, each cohomology classhas a unique harmonic 1-form.

Algorithm 5. Computing a set of Harmonic 1-Form Basis.

Input: A homology basis {γ₁,γ₂, . . . ,γ_{2g}} of M.

Output: A harmonic 1-form basis {ω₁.ω₂, . . . ,ω_{2g}}.

1. Set the values of cᵢ^{j}=−γᵢ·γⱼ, i,j=1,2, . . . ,2g.

2. Solve the following linear system for ωᵢ
δωᵢ=0
Δωᵢ=0
<ωᵢ,γⱼ>=−γᵢ·γⱼ

3. Output {ω₁,ω₂, . . . ,ω_{2g}}.

As an alternative to the algebraic approaches used above, the homology, cohomology, and harmonic 1-forms may be calculated using combinatorial algorithms as follows.

Algorithm 6. Computing a Fundamental Domain of Mesh M.

Input: A mesh M.

Output: A fundamental domain D_{M} of M.

1. Choose an arbitrary face f₀ ∈ M, let D_{M}=f₀, ∂ D_{M}=∂ f₀, put all the neighboring faces of f₀ that share an edge with f₀ into a queue Q.

2. While Q is not empty
a. Remove the first face f in Q, let
   ∂f=e₀+e₁+e₂.
b. D_{M}=D_{M}∪ f.
c. Find the first eᵢ ∈ ∂f, such that −eᵢ ∈ ∂ D_{M}, replace −eᵢ in ∂ D_{M} by {eᵢ₊₁, eᵢ₊₂}, keeping that order.
d. Put all neighboring faces that share an edge with f and not in D_{M} or Q into Q.

3. Remove all adjacent oriented edges in ∂ D_{M} that are opposite to each other, i.e., remove all pairs {eₖ, −eₖ} from ∂ D_{M}.

The resulting fundamental domain D_{M} includes all faces of M that are sorted according to their insertion order. The non-oriented edges and vertices of the final boundary of D_{M} form a graph G that is referred to as the cut graph.

For the cut graph, Algorithm 7 computes the corresponding homology generators that are also the homology basis of M.

Algorithm 7. Computing a Homology Basis of M.

Input: A mesh M.

Output: Homology basis {γ₁,γ₂, . . . ,γ_{2g}}.

1. Compute the fundamental domain D_{M} of M and determine the corresponding cut graph G.

2. Compute a spanning tree T of G, let G/T={e₁,e₂, . . . ,e_{2g}}.

3. Choose a root vertex r∈T, depth first traverse T.

4. Let ∂ eᵢ=tᵢ−sᵢ, there are paths from root r to tᵢ and sᵢ, denoted as [r,tᵢ] and [r,sᵢ] then connect them to a loop γᵢ=[r, tᵢ]−[r, sᵢ].

5. Output {γ₁,γ₂, . . . ,γ_{2g}} as a basis of H₁(G,Z) and H₁(M,Z).

To explicitly compute a basis for the cohomology group of M, H¹(M,Z), a set of closed 1-forms {ω₁,ω₂, . . . ,ω_{2g}} is found such that
<γᵢ,ωⱼ>=δᵢ^{j}. (56)
Where δᵢ^{j} is the Kronecker delta and γ_{I} is a homology basis.
Algorithm 8. Computing a Cohomology Basis of M.

Input: A mesh M.

Output: A Cohomology basis {ω₁,ω₂, . . . ,ω_{2g}}.

1. Compute a fundamental domain D_{M}, and the cut graph G of mesh M and compute a spanning tree T, G/T={e₁,e₂, . . . ,e_{2g}}.

2. Let ωᵢ(eᵢ)=1 and ωᵢ(e)=0 for any edge e∈T.

3. Suppose that D_{M} is ordered in the way that D_{M}={f₁,f₂, . . . ,fₙ}, reverse the order of D_{M} to {fₙ,fₙ₋₁, . . . ,f₁}.

4. While D_{M} is not empty:

a. retrieve the first face f of D_{M}, remove f from D_{M}, ∂ f=e₀+e₁+e₂.

b. divide {eₖ} into two sets, Γ={e∈ ∂ƒ|−e∈ ∂D_{M}}, π={e ∈ ∂ƒ|−e ∈ ∂D_{M}}.

c. choose the value of ωᵢ(eₖ),eₖ ∈π arbitrarily, such that Σ_{e∈π}ωᵢ(e)=−Σ_{e∈Γ}ωᵢ(e), if π is empty, then the right hand side is equal to zero.

d. Update the boundary of D_{M}, let ∂D_{M}=∂D_{M}+∂ƒ. Once the cohomology basis {ω₁,ω₂, . . . ,ω_{2g}} has been computed, the dual of the homology basis, {γ₁,γ₂, . . . ,γ_{2g}}, can be found by the linear transform {ω₁,ω₂, . . . ,ω_{2g}} such that
<γᵢ,ωᵢ>=−γᵢ·γⱼ. (57)
Algorithm 9. Diffuse a Closed 1-Form to a Harmonic 1-Form.

Input: A mesh M, a closed 1-form ω.

Output: A harmonic 1-form, cohomologous to ω.

1. Choose f ∈ C⁰ (M),such that Δ(ω+δƒ)≅0.

2. Solve the above sparse linear system for f.

3. Output ω+δf.
Where

$$Δ ( ω + δ f ) ( u ) = {\sum }_{[ u , v ] ∈ M} {w}_{u , v} ( ω ( [ u , v ] ) + f ( v ) - f ( u ) ) , u ∈ {K}_{0} . \qquad ( 58 )$$

Given a harmonic 1-form {ω₁,ω₂, . . . ,ω_{2g}}, the conjugate harmonic 1-form ω* can be found by solving the linear system

$${\sum }_{j = 1}^{2 g} {λ}_{j} \text{<} {ω}_{i} ⋀ {ω}_{j} , M \text{>} = \text{<} {ω}_{i} ⋀ {ω}^{*} , M \text{>} . \qquad ( 59 )$$

Once the fundamental domain has been computed, the conformal mapping may be computed directly by integrating a holomorphic 1-form ω. First, select a root vertex v₀∈D_{M} then use the depth first search method to traverse the D_{M}. Each vertex u∈D_{M} has a unique path δ from v₀ to u, then we define φ(u)=<ω,γ>.

Algorithm 10. Global Conformal Parameterization of a Mesh M

Input: A mesh M, a holomorphic 1-form ω.

Output: A map φ:D_{M}→C, or a global conformal parameterization.

1. Compute a fundamental domain D_{M} of M.

2. Use depth first search method to traverse the vertices u∈D_{M}, record the path from root vertex v₀ to u, denoted as γᵤ.

3. Compute the integration φ(u)=<ω,γᵤ>.

4. Output φ(u) as the conformal coordinates of u.

Algorithm 11. Conformal Structure of a Mesh M

Input: A mesh M.

Output: A conformal structure of M {(Uᵢ, zᵢ)}

1. Compute a holomorphic 1-form basis {ωᵢ+\sqrt{−1}ω*ᵢ}.

2. Compute a partition {Uᵢ}, such that M⊂Uᵢ, Uᵢ is simply connected.

3. For each Uᵢ choose a holomorphic base ωⱼ+\sqrt{−1}ω*ⱼ, integrate the holomorphic 1-form on Uᵢ, denote the mapping as zᵢ. If there are zero points, subdivide Uᵢ and repeat step 3.

4. Output {(Uᵢ, zᵢ)}.

The global conformal parameterization obtained by integrating a holomorphic 1-form on a fundamental domain can be used for canonical decomposition of meshes, converting meshes to a tensor product spline surface, surface matching and recognition, and other useful image processing applications.

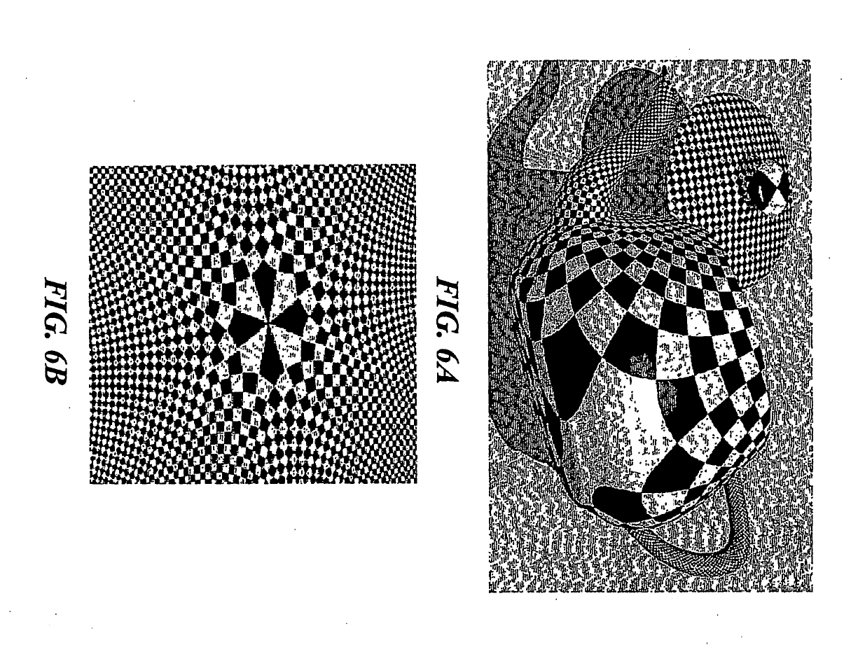

According to Poincare-Hopf theory, a holomorphic 1-form ω must have zero points if M is not homeomorphic to a torus. Zero points of ω are the points where the conformal factor is zero. A genus-g surface has 2g-2 zero points. A conformal mapping wraps the neighborhood of each point twice and double covers the neighborhood of the image of p on the complex plane. Locally the map, ω:C→C is similar in the neighborhood to
φ(z)=z² (60)
FIGS. 6a and 6b depicts the zero points on the global conformal parameterizations for an open teapot model and for the complex plane respectively.

We can treat a harmonic 1-form ω as a mapping from the surface M to the unit circle S¹. Then for a holomorphic 1-form, the harmonic 1-form of the real part is the circle valued mapping. The harmonic 1-form of the imaginary part is the gradient field. The integration curves through the zero points will subdivide the surface into regular patches. In particular, for a mesh M and a holomorphic 1-form ω=τ+\sqrt{−1}τ*, the integration curve along τ or τ* and through the zero points partitions the surface into topological disks or cylinders.

Let M be a topological torus M that is conformally mapped to C. By integrating a holomorphic 1-form ω on its universal covering space, a periodic conformal map results. Selecting a base point u₀, the image set of the base point is
{α<λ₁,ω>+b<λ₂,ω>+z₀|α,b∈Z}. (61)
This mapping is periodic, or modular. The entire torus is mapped into one period, which is a parallelogram spanned by <γ₁, ω>, <γ₂, ω>, which are referred to as the periods of M. If the genus-g of M is greater than one, different handles may have different periods. The entire surface is mapped to g overlapping modular parallelograms. The parallelograms may attach to and cross each other through the image of the zero points.

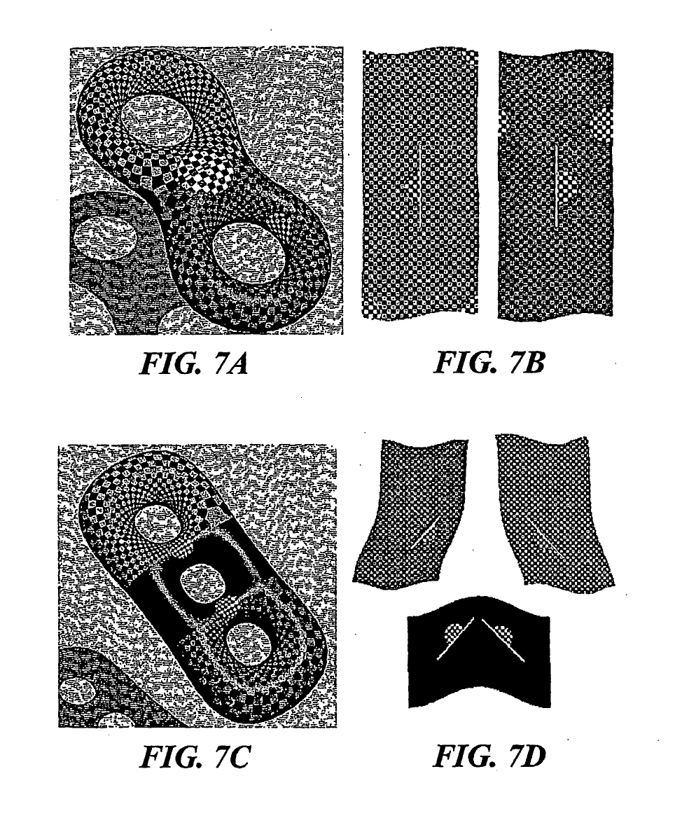

FIGS. 7a-d depict this phenomena. In FIGS. 7a and 7b a two-hole torus is separated into two handles and each handle is conformally mapped to a modular space. FIGS. 7c and 7d depict a genus-three torus and the conformal mapping into modular space.

To generalize the methods described herein meshes with boundaries will now be considered. Given a mesh M with boundaries, the doubling \overline{M} of M is computed. For each interior vertex u ∈ M, there are two copies of u in \overline{M}, which are denoted as u₁ and u₂. u₁ and u₂ are dual to each other as
\overline{u}₁=u₂, \overline{u}₂=u₁. (62)
For each boundary vertex u ∈ ∂M, there is only one copy in \overline{M}, so that u is dual to itself.

To compute the harmonic 1-forms on M, it is known that all symmetric harmonic 1-forms of \overline{M} are also harmonic 1-forms on M. Define the dual operator for each harmonic 1-form ω as
\overline{ω}([u,v])=ω([\overline{u},\overline{v}]). (63)
Any φ can be decomposed into a symmetric part and an asymmetric part as

$$ω = \frac{1}{2} ( ω + \overline{ω} ) + \frac{1}{2} ( ω - \overline{ω} ) , \qquad ( 64 )$$

where

$$\frac{1}{2} ( ω + \overline{ω} )$$

is the symmetric part and

$$\frac{1}{2} ( ω - \overline{ω} )$$

is the asymmetric part.
Algorithm 12. Computing a Set of Holomorphic 1-Form Basis for Meshes with Boundaries

Input: Mesh M with boundaries.

Output: Holomorphic 1-form basis for mesh M of the form {τ₁+\sqrt{−1}τ*₁,τ₂+\sqrt{−1}τ*₂, . . . ,τₖ+\sqrt{−1}τ*ₖ}.

1. Compute the doubling of M, \overline{M}.

2. Compute the harmonic 1-form basis of \overline{M} {ω₁,ω₂, . . . ,ω_{2g}}.

3. Assign

$${τ}_{i} = \frac{1}{2} ( ω + \overline{ω} ) ,$$

remove redundant ones.

4. Compute conjugate harmonic 1-forms of τᵢ denoted as τᵢ*.

5. Output the holomorphic basis {τ₁+\sqrt{−1}τ*₁,τ₂+\sqrt{−1}τ*₂, . . . ,τₖ+\sqrt{−1}τ*ₖ}.

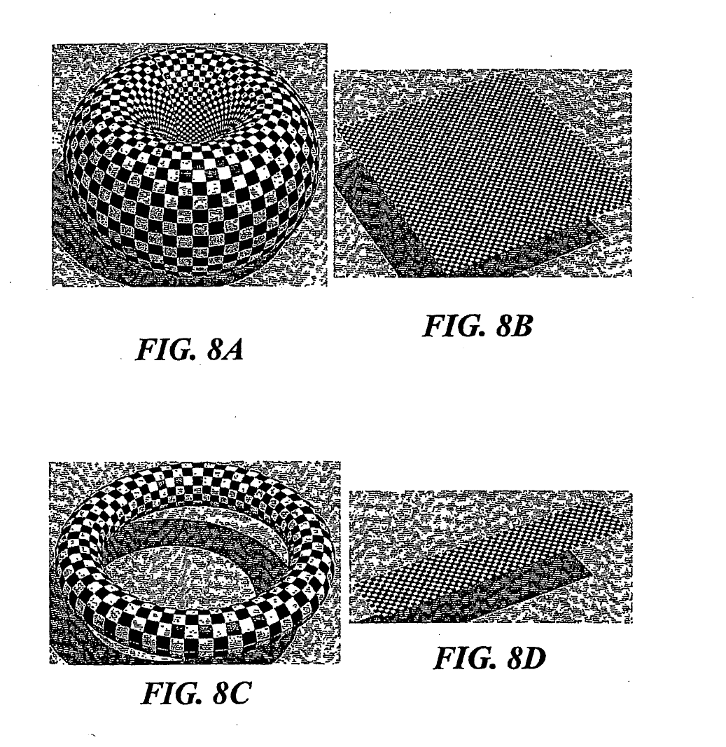

FIGS. 8a and 8c depict two genus-one surfaces, that although they are topologically equivalent, i.e., both genus-one surfaces, the two surfaces are not conformally equivalent. Each torus can be cut open and conformally mapped to a planar parallelogram as depicted in FIGS. 8b and 8d respectively. The shape of the respective parallelogram indicates the conformal equivalent class. The conformal equivalent classes are determined by the acute angle of the parallelogram, a right angle in these two cases, and length ratio between the two adjacent edges to represent the conformal invariants, or shape factors of these two genus-one surfaces. As depicted in FIGS. 8b and 8d, the two tori have different shape factors and are not conformally equivalent.

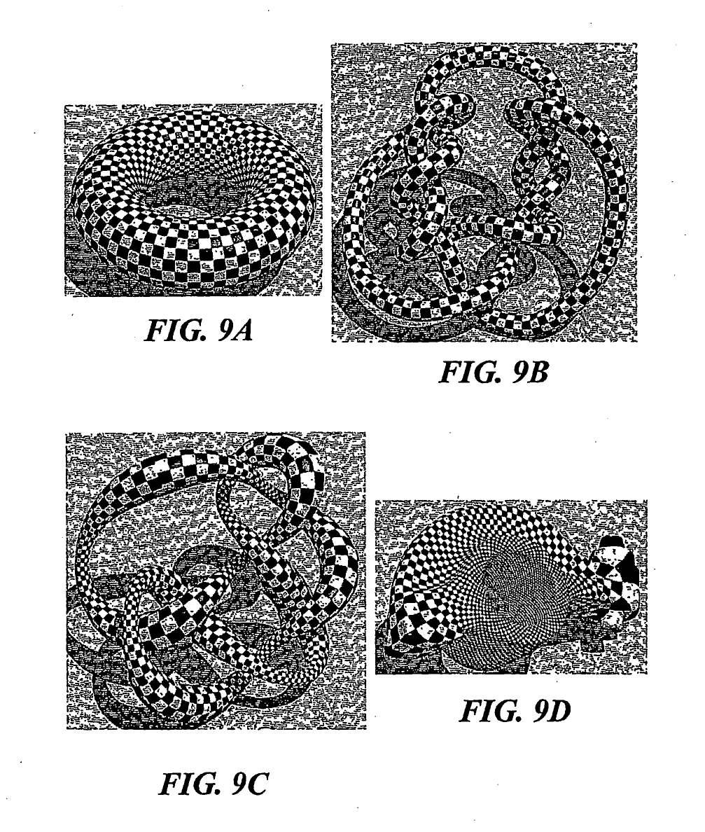

Table 1 below contains the conformal invariants of the genus-one surfaces depicted in FIGS. 9a-9d. It is clear that none of the surfaces depicted in FIGS. 9a-9d are conformally equivalent.

TABLE 1
Conformal Equivalents of Genus-one Surfaces

| Mesh | Shape Factor | Vertices | Faces |
|---|---|---|---|
| torus | 1.0 − 1.142i | 1089 | 2048 |
| knot | 1.0 − .272i | 5808 | 11616 |
| knot2 | 1.0 + 0.128i | 2050 | 3672 |
| rocker | 1.0 − 3.509i | 3750 | 7500 |
| teapot | 1.0 − .112i | 17024 | 34048 |

Algorithm 13. Verify Whether M₁ and M₂ are Conformally Equivalent

Input: Two meshes M₁ and M₂.

Output: Indicia of the conformal equivalence or not of M₁ and M₂

1. Compute period matrices (R₁, C₁) and (R₂, C₂) corresponding to M₁ and M₂ respectively.

2. Compute the Jordan normal form of R₁=P₁Γ₁P₁⁻¹ and R₁=P₂Γ₂P₂⁻¹.

3. If Γ₁≠Γ₂ return false.

4. Let N=P₁P₂⁻¹, return true if N is an invertible integer matrix and NC₁N^{t}=C₂, otherwise return false.

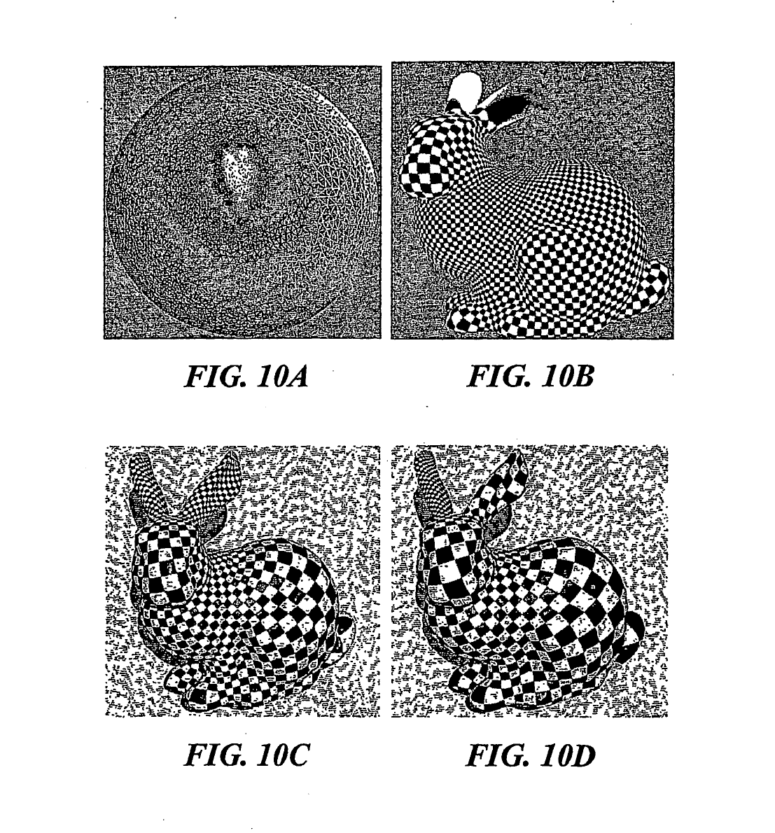

The conformal factor λ(u,v) indicates the first fundamental form of the surface S. If λ is a constant then the Gaussian curvature of the surface is zero. By selectively cutting on the surfaces, new boundaries are introduced, thus the conformal structure can be altered. In practice, it is helpful to improve the uniformity of the parameterization and in general these cuts are made on the regions of the surface having a high Gaussian curvature. FIGS. 10a-d depict the improvement in uniformity. In the spherical parameterization depicted in FIG. 10a, the ear part is highly under sampled. By introducing topology cuts at the ear tips, the parameterization becomes much more uniform.

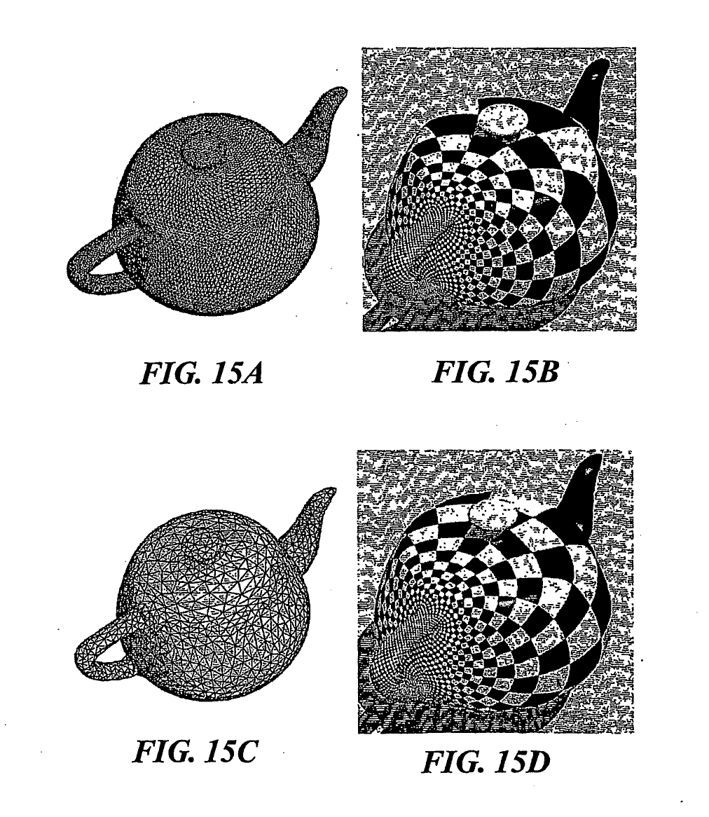

In general the stability of the computations is highly dependent on the quality of the triangulation. If all angles of the triangulation are acute angles, the computing algorithms are guaranteed to be stable and convergent. FIG. 15 depicts the global parameterization of a tea pot model at two different levels of surface model complexity. As can be seen in FIGS. 15a-b, for the more complex original tea pot the global parameterization results in all angles being acute angles and in particular right angles. FIGS. 15c-d depict the global conformal parameterization of the simplified tea pot model in which all the angles are acute angles and in particular right angles. In both cases, regardless of the complexity of the model, the computing algorithms are convergent and stable. The following algorithm approximates a triangulation with all acute angles.

Algorithm 14. Triangulation of a Surface with all Acute Angles

Input: A mesh M

Output: Remesh M with all acute angles

1. Subdivide the mesh using loop subdivision method.

2. Simplify the mesh using Edge Collapse using minimum edge length criteria.

3. Repeat steps 1 and 2 until all angles on M are acute.

4. Output the remeshed M.

Surface Matching Based on Conformal Parameter and Mean Curve Matching

If one surface can be deformed into another one without too much stretching, such as human expression or skin deformation, then the deformation can be accurately approximated by global conformal mapping. Since conformal parameterization depends on the first fundamental form of the surfaces, and in particular the conformal structure depends on the Riemann metric continuously, as long as the Riemannian metric tensor does not change too much, the conformal structures are similar. Thus, mapping two surfaces to a canonical parameter domain and matching the surfaces in the parameter domain allows 3-D matching problems to be solved more efficiently.

By storing the conformal factor λ(u,v) and normal n(u,v) on the parameter domain, the original surfaces can be reconstructed uniquely up to rotation and translation in R³. λ(u,v) defines the first fundamental form and n(u,v) defines the third fundamental form and hence the second fundamental form, i.e., the embedding in R³ can be computed. Thus, the surface can be constructed uniquely up to a Euclidean transformation.

A more efficient method is to use the mean curvature on the conformal parameter domain. For any closed surface without boundaries, the surface is uniquely determined by the conformal factor λ(u,v) and mean curvature H. For any open surface with a boundary, the surface is uniquely determined by the conformal factor λ(u,v), the mean curvature H, and the second fundamental form on the boundary.

To match surfaces based on Gaussian curvature and mean curvature, the surfaces to be matched are embedded in a canonical parameter domain. For example, a human face can be mapped to a unit disk. The Gaussian curvature and mean curvature are computed using conformal parameterization. The level sets of Gaussian curvature and mean curvature are families of planar curves on the parameter domain. These level sets of curves are then used to match the surfaces.

To match surfaces that contain special features, the feature points are first removed and the doublings of the surfaces are computed. Next, the homotopy type of the map are constrained to guarantee that the features in the first surface are matched to corresponding features in the second surface. The conformal structures are then computed to perform the matching as described above. For example, to match human faces, the features such as the eyes, tip of the nose, and the mouth are removed prior to computing the conformal structure.

Surface Classificaiton

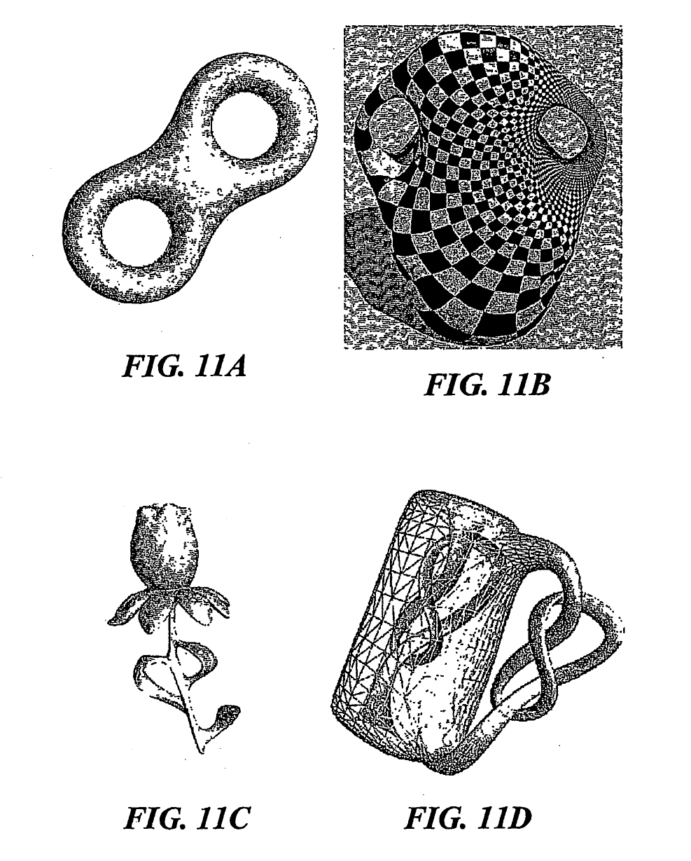

To classify surfaces to allow efficient databasing and searching, the conformal structure in the form of the period matrices for each surface are computed and stored. FIGS. 11a-d depict various genus-two surfaces. As can be seen below, none of the surfaces depicted in FIGS. 11a-d are conformally equivalent as the period matrices R are not equivalent.

The two-hole torus of FIG. 11a includes 861 vertices and 1536 faces and has a period matrix R that is

$$( \begin{matrix}- 1.475 e - 3 & 4.840 e - 4 & 4.501 e - 1 & 2.132 e - 2 \\ 4.858 e - 4 & —1 .439 e - 3 & 2.132 e - 2 & 4.501 e - 1 \\ - 2.260 e + 0 & 1.090 e - 1 & 1.467 e - 3 & - 4.858 e - 4 \\ 1.090 e - 1 & - 2.250 + 0 & - 4.840 e - 4 & 1.439 e - 3\end{matrix} ) \qquad ( 65 )$$

The vase model depicted in FIG. 11b has 1582 vertices and 2956 faces and a period matrix R that is

$$( \begin{matrix}1.053 e - 3 & - 8.838 e - 6 & 4.479 e - 1 & 2.127 e - 2 \\ - 1.080 e - 4 & - 1.031 e - 3 & 2.172 e - 2 & 4.042 e - 1 \\ 2.309 e + 0 & 1.241 e - 1 & 1.053 e - 3 & - 1.080 e - 4 \\ - 1.214 e - 1 & - 2.564 e + 0 & 8.851 e - 6 & 1.031 e - 3\end{matrix} ) \qquad ( 66 )$$

The flower model depicted in FIG. 11c has 5112 vertices and 10000 faces and a period matrix R that is

$$( \begin{matrix}6.634 e - 3 & - 1.950 e - 3 & 2.861 e - 1 & - 6.076 e - 2 \\ - 1.909 e - 3 & 7.091 e - 3 & - 6.076 e - 2 & 2.497 e - 1 \\ - 3.768 e + 0 & - 9.111 e - 1 & - 6.634 e - 3 & 1.909 e - 3 \\ - 9.111 e - 1 & - 4.303 e + 0 & 1.950 e - 3 & - 7.091 e - 3\end{matrix} ) \qquad ( 67 )$$

The knotty bottle depicted in FIG. 11d has 15000 vertices and 30000 faces and a period matrix R that is

$$( \begin{matrix}- 1.911 e - 2 & 2.757 e - 3 & 5.617 e - 2 & - 1.001 e - 3 \\ 1.213 e - 3 & - 9.294 e - 2 & - 1.003 e - 3 & 5.699 e - 2 \\ - 1.792 e + 1 & - 4.829 e - 1 & 1.912 e - 2 & - 6.224 e - 4 \\ - 4.817 e - 1 & - 1.819 e + 1 & - 3.355 e - 3 & 9.295 e - 2\end{matrix} ) \qquad ( 68 )$$

Surface Recognition

It is desired that surfaces can be recognized without having to be matched to one another directly. Modifying the conformal structure of the surface in a canonical way and computing the period matrices for each modification provides a sequence of period matrices that indicate the intrinsic geometric properties of the surface.

For example, to recognize a human face, the feature points, such as the center of the left eye, the center of the right eye, the nose tip, and center of the mouth are removed. For each modification to the facial surface, the doubling of the surface and the period matrices are computed. By comparing sequences of period matrices, we can recognize a geometric surface, such as a face.

Alternatively, all the major feature points are removed and another point is selected and moved within the surface and period matrices of the doubling are computed for each movement of the selected point. For example to recognize a human face the points at the center of the eyes, the tip of the nose, and the center of the mouth are removed and another point on the face is moved along a prescribed orbit. At each step, the point at the current location is removed and the period matrix computed. A sequence of period matrices will be computed, one for each point along the prescribed orbit. It is these period matrices that are used to recognize the surface.

Harmonic Spectrum Analysis

Alternatively, the Laplacian operator, described above, has infinite eigen values and eigen functions. The spectrum of all the eigen values reflects much of the intrinsic geometry of the surface. In addition, the eigen functions can be used to reconstruct the surface. Rhe surface can be recognized using only the spectrum of the surface as the signature of the surface. For example, in the medical field, by analyzing the spectrum of the shape of internal organs some illnesses may be detected.

The desired eigen values and eigen functions can be computed for a surface represented by a triangular mesh by finding the eigen values and eigen vectors of the Laplacian matrix.

Compression of Surface Data using Hamonic Eigen Functions

A genus-zero surface is conformally mapped to the unit sphere and the position vector of the surface is represented as a vector valued function defined on the sphere. The eigen-functions of the Laplacian operator on the sphere are the spherical harmonics that form a basis for the functional space of the sphere. The position vector is then decomposed with respect to the functional basis and the spectrum is obtained. By filtering out the high frequency components, the surface data is compressed. Through the use of a Möbius transformation, described above, a region can be “zoomed into” for further examination. For general surfaces, conformally mapping the surface to a canonical shape in its conformal equivalent class and decomposing the surface position vector using the eigen-functions of the Laplacian operator provides the desired functional basis from which the high frequency components can be removed prior to storage.

Alternatively, the conformal factor and mean curvature defined on the conformal coordinates can be used to determine the surface uniquely to a Euclidean transformation. In this method the two functions defined on the plane, i.e., the conformal factor and mean curvature, are used to represent the surface. Thus, a savings of one-third the storage is realized. Further compression may be obtained by using the eigen-function technique described above or other known compression techniques.

Remeshing and Hardware Design

By using conformal structure, we can remesh the surface after it has been conformally mapped into the parameter domain. In this way the irregular connectivity can be changed to regular triangulation. In theory, the reconstructed normals are accurate. This will simplify the representation of geometric data, and simplify the graphic hardware architecture. Currently, for general graphics hardware, there are memory buffers for storing connectivity information. The communication of between CPU and the graphics card that is necessary to specify this connectivity information is extremely time consuming. If the connectivity of the data stored within the memory on the graphics card is regular, and the graphics card can predict it by itself, then no extra memory will be needed for connectivity information. Thus, reducing the necessary level of communication between the processor and the graphics card. With respect to the architecture of graphics cards, currently the pipeline for processing the geometry and the pipeline for processing surface texture are separate. Using regular connectivity, geometry can be represented as texture also, and these two separate pipelines can be combined. In this way, the complexity of the graphics card architecture can be reduced.

Also by remeshing, geometry images can be constructed and the image format can be used to represent the surface geometry. In this way, many image processing techniques that operate on the geometry, such as compression, multi-resolution, and filtering, among others, can be used.

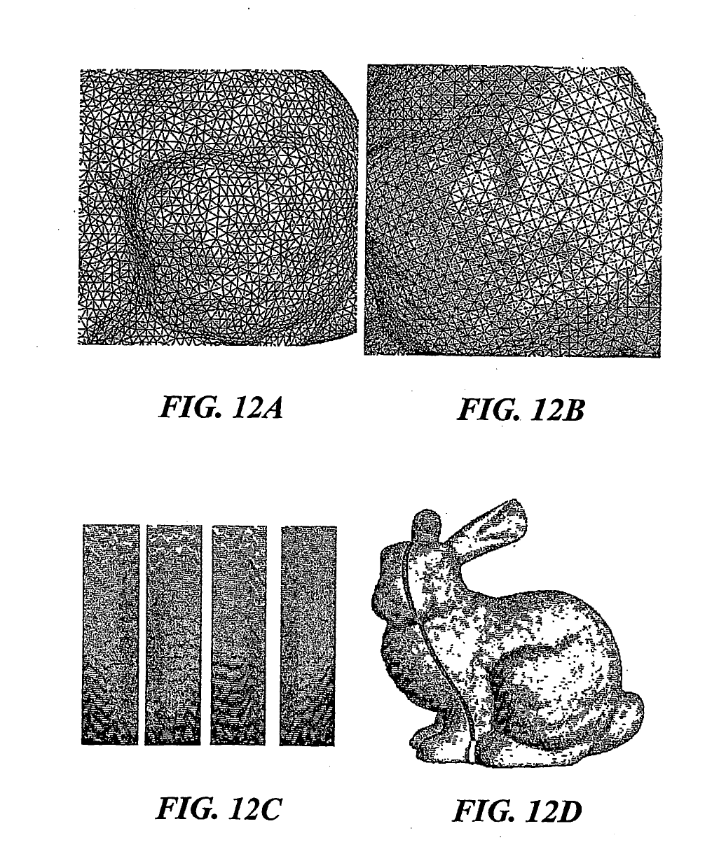

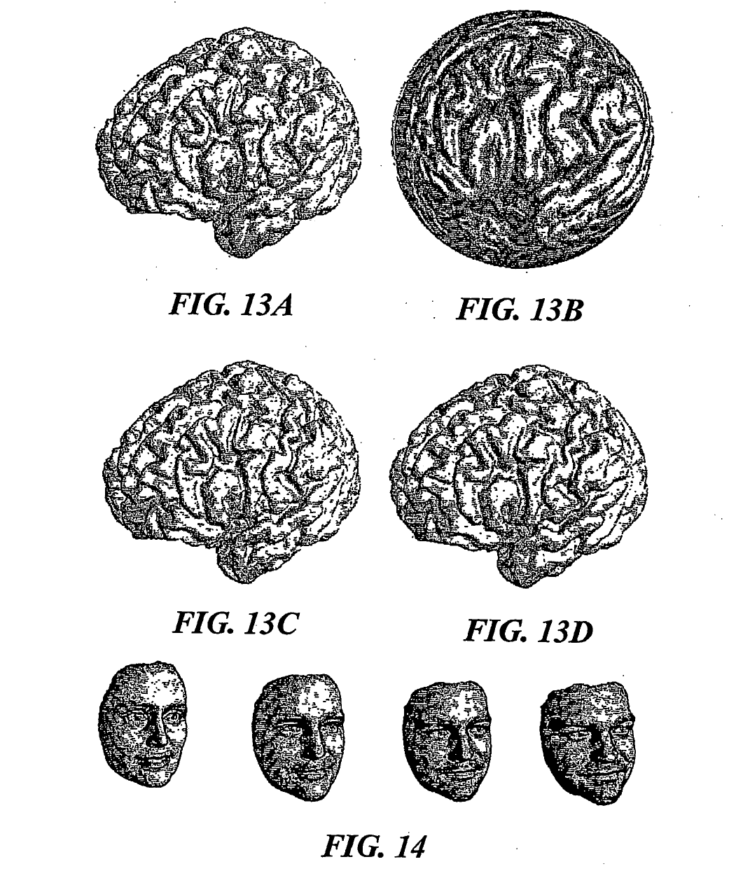

FIG. 12a depicts a bunny model having irregular connectivity of the original mesh. After remeshing using the conformal structure, as depicted in FIG. 12b the connectivity is very regular and the reconstructed normals are very accurate. The conformal geometry image is shown in FIG. 12c, and the reconstructed shape is depicted in FIG. 12d.

Parametric Surface and Mesh Conversion

In the CAGD field, parametric surfaces such as BSpline surfaces and Bezier surfaces are used frequently. In the manufacturing industry, a controller that makes use of these kinds of parametric surfaces often guides the processing machines. However, geometric data are often represented as triangle meshes. Current geometric data acquisition devices output geometric data as dense point clouds. It is easier to convert these scanned point clouds into meshes and therefore it is very important to convert parametric surfaces to and from meshes. Currently, there are no automatic methods to convert meshes to Spline surfaces.

By using the conformal geometry techniques described herein, this problem can be solved. As discussed above, a global conformal parameterization of the surface is computed and the surface is decomposed to canonical patches using the integration lines along the gradient field through zero points. Each canonical patch is mapped to a rectangle on the plane, and a tensor product spline surface is constructed on it. The resulting parameterization can be made globally smooth by matching the control points on the boundary. Hence, it is convenient to convert the mesh to parametric surfaces with an arbitrary desirable continuity. In addition, this construction preserves accurate normal information.

Numerical Computation on Surfaces

Conformal structure is a good parameterization for computing covariant differentiations on surfaces. Covariant differentiation is intrinsic to the surface geometry, so the embedding in the Euclidean surface is irrelevant. Conformal structural analysis has potential to compute natural physical processes on deformable surfaces.

By using conformal coordinates, the differential operators have a very simple format. For an example the Laplacian operator is

$${Δ}_{S} = {\sum }_{α} \frac{1}{{λ}^{2}} \frac{\partial }{\partial {x}_{α}} \frac{\partial }{\partial {x}_{α}} . \qquad ( 69 )$$

This technique allows for the easier solution of surface partial differential equations such as Navier-Stokes equations and Maxwells equations. Using the conformal structure described above, the Gaussian curvature of a surface is easily determined.

Medical Imaging

The conformal structures described above can also be applied in the medical imaging field, such as in brain mapping, brain registration, heart surface matching, and vessel surface analysis. For example, by mapping the brain surface to the unit sphere, it is convenient to compare two brains and match the features. By analyzing the geometric structures on the brain, it is easier to find changes to a brain over time and to find potential illnesses.

The conformal map from a brain surface to a sphere is independent of triangulation and resolution. The conformal mapping provides a nice canonical space for us to compare and register two brain surfaces. Since the brain surface is very complicated, it is very hard for other methods to trace the evolution of the vertex's flow. The methods described herein handle the complicated surface structures while maintaining accurate angle information. Since the brain is typically a genus-zero surface, Algorithm 1, described above, may be used to map the brain surface to the unity sphere. FIG. 14 shows examples for a brain mapping.

Animation

Conformal geometry can also be applied to computer graphics animation. Using current data acquisition technology, 3D shapes of an actor can be scanned with different gestures and expressions. Using the conformal analysis techniques described above, these key gestures and expressions can be mapped to one another. By using spline interpolation techniques, smooth transitions between the gestures and expressions can be generated between them. Thus, arbitrary shapes can be animated, including soft shapes and deformable models, which are extremely difficult to animate using current methods.

Suppose we are given two similar shapes. First the feature points are located, and then removed. The doubling of the surfaces is computed and the homotopy type of the mapping is determined. A holomorphic 1-form on each surface is selected, such that the cohomology type of the two surfaces are determined by the mapping homotopy type. The zero points are located, the surfaces are decomposed to patches using gradient lines through the zero points. Each of the patches is conformally mapped to a rectangle in the parameter domain. To obtain the map between the surfaces, these patches on the plane are then matched.

Once the mapping between key shapes is known, the points on the key shapes are selected to serve as the control points. A BSpline is used to generate smooth transitions among key shapes. This is depicted in FIG. 15 in which a human female face is morphed using conformal structures into a human male face. In this way, we can animate any arbitrary shape. This is especially useful for human actors. Facial expressions, gestures, and skin deformations of actors at different ages can be stored in a database. These stored geometric data can be animated to form virtual actors.

Texture Mapping without Distortion

Texture mapping of surfaces is very important in both the computer gaming industry and the movie industry. The rendering speed of a surface is determined by, among other factors, the complexity of the geometric model being displayed. For real time applications, such as a computer game, simple models are typically preferred. In order to improve the perceptual quality of the image, images are pasted on the geometric surface using a process referred to as texture mapping.

For a curved surface, texture mapping introduces some distortions in the displayed image. The most challenging task for introducing texture is to avoid distortion between textures in plane and on the curved surface. In industry, geometric modelers and texture designers are typically different professionals with different expertise. Because texture mapping needs to modify both geometry and texture, the coordination between these two different skill sets are usually difficult and time consuming.

As discussed above, conformal parametrization has no local distortion. Using the techniques described above, a geometric modeler and a texture designer can integrate their skills easier and more efficiently than before.

Texture Synthesis using Dirichlete Method

Texture synthesis aims to generate textures to cover a given surface from a small texture sample. This is an important consideration for graphics design, the movie industry and the computer gaming industry.

Using conformal parameterization, the difficult problem of texture synthesis on a geometric surface can be converted into an easier problem of texture synthesis on a plane. Using the conformal factor analysis and techniques described above, the stretching of the texture displayed on the surface can be controlled and the geometric properties of the texture on the surface can be accurately predicted.

In order to make the synthesized texture globally smooth, we use the Dirichlete method to diffuse the boundaries of texture patches. This will make the texture more natural and smoother. First the disjoint texture patches on the parameter plane with controlled stretching effect are determined. These patches are grown until their respective boundaries meet but do not overlap. The boundaries of these patches are fixed and the Dirichlet problem is solved in the uncovered regions on the surface. Each of the color channels are treated as a function, and the techniques described above will provide solutions that will provide for- a global smooth texture on the surface.

Volumetric Harmonic Mapping

Given a 3D manifold, M, a map f: M→R³ is desired that minimizes the harmonic energy. In this way the volumetric mapping of the original 3D mainfold can be studied in a canonical space. The Harmonic energy for f: M→R³ is defined as

$$E ( f ) = {\int }_{M} {‖ ∇ f ‖}^{2} ⅆ {δ}_{M} . \qquad ( 70 )$$

For a discrete system, the harmonic energy is defined as

$$E ( f ) = {\sum }_{[ u , v ] ε M} {k}_{uv} ‖ f ( u ) - f ( v ) ‖ \qquad ( 71 )$$

where

$${k}_{uv} = \frac{1}{48} {\sum }_{θ} cot ( θ ) ,$$

θ is the dihedral angle opposite to the given edge and 1 is the edge length.

The conjugate gradient method can then be used to minimize the harmonic energy in order to obtain the harmonic mapping. A volumetric harmonic map can be found to map a genus-zero 3D object onto a sphere. For the canonical circles on the sphere, a closed simple curve on the genus zero object can be found. A Plateau problem on the curves can be solved for a conformal deformed metric. In this way a canonical description of the volume enclosed by a surface can be obtained.

Harmonic mapping is also a useful tool in surgery simulation and planning. A physician can construct a 3D brain volumetric model from one or more MRI images of the body area of interest. These MRI images can be mapped onto a 3D sphere. The Physician can build a 3D atlas of the body area of interest and compare the 3D volumetric data of the new patient's body area of interest with the existing atlas data. Because harmonic mapping is unique, this technique is a useful method to register brain volumetric data and would be useful for developing surgery simulations.

Those of ordinary skill in the art should further appreciate that variations to and modifications of the above-described methods may be made without departing from the inventive concept disclosed herein. Accordingly, the invention should be viewed as limited solely by the scope and spirit of the appended claims.

What is claimed is:

1. (canceled)

2. A method for computing the conformal structure of a surface, the method comprising:
receiving a first mesh representation M of said surface;
conformally mapping said mesh representation to a canonical parameter domain forming a first mapped surfaces; and
computing a conformal parameterization of said first mapped surface.

3. The method of claim 1 wherein the step of computing said conformal parameterization includes:
computing a homology basis {γ₁, γ₂, . . . ,γ_{2g}} of said mesh representation, wherein computing said homology basis includes the steps of:
computing a set of boundary matrices ∂₁, ∂₂ for said mesh representation, respectively;
forming a matrix D, wherein D=∂₂∂₂^{T}+∂₁^{T}∂₁;
computing the Smith normal for said matrix D; and
computing the eigenvectors of D corresponding to zero eigenvalues that are equal to {γ₁, γ₂, . . . , γ_{2g}}, and wherein {γ₁, γ₂, . . . ,γ_{2g}) are a homology basis of said mesh representation.

4. The method of claim 2 wherein the step of computing the conformal parameterization includes the step of computing a set of harmonic 1-form basis, wherein the step of computing said set of harmonic 1-form basis includes the steps of:
calculating the value of cᵢ^{j}=−γᵢ·γⱼ, i,j 32 1, 2, . . . , 2g wherein γᵢ, γⱼ is the homology basis of the mesh representation; and
solving the linear system δωᵢ=0, Δωᵢ=0, <ωᵢ, γⱼ>=−γᵢ·γⱼ for ωᵢ, wherein {ω₁, ω₂, . . . , ω_{2g}} is the desired harmonic 1-form basis of said mesh representation.

5. The method of claim 3 wherein the step of computing the conformal parameterization further includes the steps of:
computing the fundamental domain D_{M} of the mesh representation, wherein the step of computing the fundamental domain D_{M} of the mesh representation includes the steps of:
selecting an arbitrary face, f₀ ∈ M;
setting D_{M} to f₀;
setting ∂D_{M}=∂f₀;
placing all neighboring faces of f₀ that share an edge with f₀ in a queue, Q;
while Q is not empty:
reading the first face in Q;
setting ∂f=e₀+e₁+e₂;
setting D_{M}=D_{M} ∪ f;
finding the first eᵢ ∈ ∂f such that −eᵢ ∈ ∂D_{M};
replacing −eᵢ in ∂D_{M} with {e₍ᵢ₊₁₎, e₍ᵢ₊₂₎};
putting in Q all the neighboring faces that share an edge with f in the mesh representation and that are not in D_{M} or Q; and
removing all adjacent oriented edges in ∂D_{M} that are opposite each other in sign.

6. The method of claim 4 wherein the step of calculating said conformal parameterization of said first mapped surface further includes the steps of:
recording a first path δ from root vertex v₀ to u by traversing all the vertices u ∈ D_{M};
computing the integration of φ(u)=<ω, γᵤ>; and
providing as an output φ(u) as the conformal coordinates of u.

7. The method of claim 5, wherein the step of calculating said conformal parameterization of said first mapped surface further includes the step of calculating the cohomology basis, wherein the step of calculating the cohomology basis includes the steps of:
setting ωᵢ(eᵢ)=1 and ωᵢ(eⱼ)=0 for any edge e ∈ T;
ordering D_{M} such that D_{M}={f₁, f₂, . . . , fₙ);
reversing the order of D_{M} to {fₙ, fₙ₋₁, . . . , f₁};
while D_{M} is not empty:
retrieving the first face f of D_{M};
removing f from D_{M}, ∂f=e₀+e₁+e₂;
divide {eₖ} into two sets, Γ={e ∈ ∂f|−e∈ ∂D_{M}}, π={e ∈δƒ|−e ∉ ∂D_{M}};
choosing the value of ωᵢ(eₖ), eₖ ∈π arbitrarily, such that Σ_{e∈π}ωᵢ(e)=−Σ_{e∈Γ}ωᵢ(e), and if π is empty, then the right hand side is equal to zero;
updating the boundary of D_{M}, let ∂D_{M}=∂D_{M}+∂f; and
computing the dual of the homology basis, {γ₁,γ₂, . . . ,γ_{2g}}, by the linear transform {ω₁,ω₂, . . . , ω_{2g}} such that <γᵢ,ωⱼ>=−γᵢ·γⱼ.

8. The method of claim 1, wherein the step of conformally mapping and calculating said conformal parameterization of said mesh representation includes the step of calculating the holomorophic 1-form, wherein the step of calculating the holomorphic 1-form includes the steps of:
computing the doubling of M, \overline{M};
computing the harmonic 1-form basis of \overline{M} {ω₁,ω₂, . . . , ω_{2g}};
assigning
$${τ}_{i} = \frac{1}{2} ( ω + \overline{ω} )$$
and removing-redundant ones.;
computing conjugate harmonic 1-forms of τᵢ denoted as τᵢ*; and
outputting the holomorphic 1-form basis {τ₁+\sqrt{−1}τ*₁,τ₂+\sqrt{−1}τ*₂, . . . , τₖ+\sqrt{−1}τ*ₖ}.

9. The method of claim 7 wherein the step of doubling M to form \overline{M} includes the steps of:
copying M, denoted as −M;
reversing the orientation of −M;
finding for each boundary vertex u ∈ ∂M, a unique corresponding boundary vertex −u ∈ ∂ −M;
finding for any edge on e ∈ ∂M a unique boundary edge −e ∈ ∂ −M; and
gluing M and −M such that the corresponding vertices and edges are identical, wherein the resulting mesh is the doubling \overline{M}.

10. The method of claim 7 wherein the step of calculating said conformal parameterization of said mesh representation, M, further includes the step of calculating a conformal structure, wherein the step of calculating the conformal structure includes the steps of:
a) providing the holomorphic 1-form basis {τᵢ+\sqrt{−1}τ*ᵢ};
b) computing a partition {Uᵢ}, such that M ⊂ Uᵢ, Uᵢ being simply connected;
c) for each Uᵢ, selecting a holomorphic 1-form base ωⱼ+\sqrt{−1}ω*ⱼ;
d) integrating the holomorphic 1-form on Uᵢ, denoting the mapping as zᵢ, and in the event that there are zero points, subdivide Uᵢ and repeat the integration; and
e) outputting the conformal structure {(Uᵢ, zᵢ)}.

11. The method of claim 4 wherein the step of calculating said conformal parameterization of said mesh representation further includes the step of calculating the period matrices, wherein the step of calculating the period matrices includes the steps of:
calculating the elements of a matrix C as cᵢⱼ=<γᵢ, ωⱼ>;
calculating the elements of a matrix S as sᵢⱼ=<γᵢ, ωⱼ*>; and
calculating the matrix R as the solution of CR=S where R satisfies R²=−I, where I is the identity matrix.

12. A method for classifying a surface, the method comprising the steps of:
receiving a mesh representation of the surface;
computing a period matrix R corresponding to said mesh representation of the surface; and
storing said period matrix R.

13. The method of claim 11 wherein the step of computing said period matrix R includes the steps of:
computing a homology basis {γ₁, γ₂, . . . , γ_{2g}} of said mesh representation, wherein computing said homology basis includes the steps of:
computing a boundary matrix ∂₁, ∂₂ for said mesh representation;
forming a matrix D, wherein D=∂₂∂₂^{T}+∂₁^{T}∂₁;
computing the Smith normal for said matrix D; and
computing the eigenvectors of D corresponding to zero eigenvalues that are equal to {γ₁, γ₂, . . . , γ_{2g}} wherein {γ₁, γ₂, . . . , γ_{2g}} are a homology basis of said mesh representation.

14. The method of claim 12 wherein the step of calculating said period matrix R further includes the step of computing a set of harmonic 1-form basis, wherein the step of computing said set of harmonic 1-form basis includes the steps of:
calculating the value of cᵢ^{j}=−γᵢ·γⱼ i, j=1, 2, . . . , 2g, wherein γᵢ, γⱼ are the homology basis of the mesh representation; and
solving the linear system δωᵢ=0, Δωᵢ=0, <ωᵢ, γⱼ>=−γᵢ·γⱼ for ωᵢ, wherein {ω₁, ω₂, . . . , ω_{2g}} is the desired harmonic 1-form basis of the mesh representation.

15. The method of claim 13 wherein the step of computing said period matrix R further includes:
calculating the elements of a matrix C as cᵢⱼ=<γᵢ, ωⱼ>;
calculating the elements of a matrix S as sᵢⱼ=<γᵢ, ωⱼ*>; and
calculating the period matrix R as the solution of CR=S where R satisfies R²=−I, where I is the identity matrix.

16. A method for matching first and second surfaces, the method comprising:
receiving first and second mesh representations of said first and second surfaces, respectively;
conformally mapping both of said first and second mesh representations to a first canonical parameter domain, thereby forming first and second mapped surfaces;
computing first and second conformal parameterizations of said first and second mapped surfaces, respectively;
computing first and second level sets of Gaussian curvature and mean curvature for said first and second mapped surfaces, respectively, wherein said first and second level sets of Gaussian curvature and mean curvature are a function of said first and second conformal parameterizations, respectively; and
comparing said first and second level sets of Gaussian curvature and mean curvature and in the event that the comparison exceeds a predetermined threshold, declare a match between said first and second surfaces, otherwise declare a mismatch between said first and second surfaces.

17. The method of claim 15 wherein the step of computing said first and second conformal parameterizations includes the step of:
computing a homology basis {γ₁₁, γ₁₂, . . . , γ_{12g}} and {γ₂₁, γ₂₂, . . . , γ_{22g}} of said first and second mesh representations, respectively, wherein computing said homology basis includes the steps of:
computing first and second sets of first and second boundary matrices ∂₁₁, ∂₁₂ and ∂₂₁, ∂₂₂ for said first and second mesh representations, respectively;
forming first and second matrices D₁ and D₂, respectively, wherein D₁=∂₁₂∂₁₂^{T}+∂₁₁^{T}∂₁₁ and D₂=∂₂₂∂₂₂^{T}+∂₂₁^{T}∂₂₁;
computing the Smith normal for said matrices D₁ and D₂; and
computing the eigenvectors of D1 and D2 corresponding to zero eigenvalues that are equal to {γ₁₁, γ₁₂, . . . , γ_{12g}} and {γ₂₁, γ₂₂, . . . , γ_{22g}} wherein {γₓ₁, γₓ₂, . . . , γ_{x2g}} are a homology basis of said first and second mesh representations, respectively.

18. The method of claim 16 wherein the step of computing said first and second conformal parameterizations further includes the step of computing a first and second set of harmonic 1-form basis, wherein the step of computing said first and second set of harmonic 1-form basis includes the steps of:
calculating the value of c₁ᵢ^{j}=−γ₁ᵢ·γ₁ⱼ, ij=1, 2, . . . , 2g and c₂ᵢ^{j}=−γ₂ᵢ·γ₂ⱼ, i, j=1, 2, . . . , 2g wherein γ₁ᵢ, γ₁ⱼ and γ₂ᵢ, γ₂ⱼ are the homology basis of the first and second mesh representations, respectively;
solving the linear system δω₁ᵢ=0, δω₁ᵢ=0, <ω₁ᵢ, γ₁ⱼ>=−γ₁ᵢ·γ₁ⱼ for (ω₁ᵢ, wherein {ω₁₁, ω₁₂, . . . , ω_{12g}} is the desired harmonic 1-form basis of the first mesh representation; and
solving the linear system δω₂ᵢ=0, Δω₂ᵢ=0, <ω₂ᵢ, γ₂ⱼ>=−γ₂ᵢ·γ₂ⱼ for ω₂ᵢ, wherein {₂₁, ω₂₂, . . . , ω_{22g}} is the desired harmonic 1-form basis of the second mesh representation.

19. The method of claim 17 wherein the step of computing said first and second conformal parameterizations further includes the step of computing the fundamental domain D_{1M} and D_{2M} of the first and second mesh representations respectively, wherein the step of computing the fundamental domain D_{1M} and D_{2M} of the first and second mesh representations respectively includes the steps of:
selecting an arbitrary face, f₁₀ ∈ M₁ and f₂₀ ∈ M₂, and set D_{1M} and D_{2M} to f₁₀ and f₂₀ respectively;
setting ∂D₁ₘ=∂f₁₀ and ∂D₂ₘ=∂f₂₀;
placing all neighboring faces of f₁₀ and f₂₀ that share an edge with f₁₀ and f₂₀ respectively in a queue, Q₁ and Q₂, respectively;
while Q₁ and Q₂ are not empty:
reading the first face in Q₁ and Q₂;
setting ∂f₁=e₁₀+e₁₁+e₁₂;
setting D_{1M}=D_{1M}∪f₁;
finding the first e₁ᵢ ∈ ∂f₁ such that −e₁ᵢ ∈ ∂D_{1M};
replacing −e₁ᵢ and −e₂ᵢ in ∂D_{1M} and ∂D_{2M}, respectively, with {e₁₍ᵢ₊₁₎, e₁₍ᵢ₊₂₎} and {e₂₍ᵢ₊₁₎, e₂₍ᵢ₊₂₎}, respectively;
putting all the neighboring faces that share an edge with f₁ and f₂ in the first and second mesh representations, respectively, and that are not in D_{1M} and Q₁ and D_{2M} and Q₂, respectively, into Q₁ and Q₂, respectively; and
removing all adjacent oriented edges in ∂D_{1M} and ∂D_{2M} that are opposite each other in sign.

20. The method of claim 15 wherein said first and second surfaces are human faces.

21. The method of claim 15 wherein said canonical parameter domain is a disk.

22. A method for recognizing a surface represented by a mesh representation, M, the method comprising the steps of:
receiving the mesh representation of the surface;
removing at least one feature point from the mesh representation;
doubling the mesh representation, M;
computing the period matrix, R, for the mesh representation, M, having at least one feature point removed;
comparing the period matrix, R, corresponding to the mesh representation with at least one standard period matrix corresponding to a standard surface;
in the event that the period matrix, R, corresponding to the mesh representation and the at least one standard period matrix corresponding to a standard surface are within a predetermined factor of one another, providing indicia that the surface represented by the mesh representation is recognized as being substantially similar to the at least one standard surface.

23. The method of claim 21, wherein the step of doubling the mesh representation, M, includes the steps of:
copying M, denoted as −M;
reversing the orientation of −M;
finding for each boundary vertex u ∈ ∂M a unique corresponding boundary vertex −u ∈ ∂ −M;
finding for any edge on e ∈ ∂M a unique boundary edge −e ∈ ∂ −M; and
gluing M and −M such that the corresponding vertices and edges are identical, wherein the resulting mesh is the doubling \overline{M}.

24. The method of claim 21, wherein the step of computing the period matrix R includes the steps of:
computing a homology basis {γ₁, γ₂, . . . , γ_{2g}} of said mesh representations, wherein computing said homology basis includes the steps of:
computing a set of boundary matrices ∂₁, ∂₂ for said mesh representations;
forming a matrix D, wherein D=∂₂∂₂^{T}+∂₁^{T}∂₁;
computing the Smith normal for said matrix D; and
computing the eigenvectors of D corresponding to zero eigenvalues that are equal to {γ₁, γ₂, . . . , γ_{2g}} wherein {γ₁, γ₂, . . . , γ_{2g}} are a homology basis of said mesh representation.

25. The method of claim 23 wherein the step of calculating said period matrix R further includes the step of computing a set of harmonic 1-form basis, wherein the step of computing said set of harmonic 1-form basis includes the steps of:
calculating the value of cᵢ^{j}=−γᵢ·γⱼ, i,j=1, 2, . . . , 2g, wherein γᵢ, γⱼ are the homology basis of the mesh representation; and
solving the linear system δωᵢ=0, Δωᵢ=0, <ωᵢ, γⱼ>=−γᵢ·γⱼ for ωᵢ, wherein {ω₁, ω₂, . . . , ω_{2g}} is the desired harmonic 1-form basis of the mesh representation.

26. The method of claim 24 wherein the step of computing said period matrix R further includes:
calculating the elements of a matrix C as cᵢⱼ=<γᵢ, ωⱼ>;
calculating the elements of a matrix S as sᵢⱼ=<γᵢ, ωⱼ*>; and
calculating the matrix R as the solution of CR=S where R satisfies R²=−I, where I is the identity matrix.

27. A method for recognizing a surface represented by a mesh representation, M, the method comprising the steps of:
receiving the mesh representation of the surface;
removing substantially all feature points from the mesh representation;
selecting an arbitrary point on the surface of the mesh representation, M;
selecting an arbitrary orbit along the surface of the mesh representation, M, for the arbitrary point to follow;
moving the arbitrary point along the arbitrary orbit;
removing the arbitrary point from the mesh representation, M, at at least one point along the arbitrary orbit;
doubling the mesh representation, M, having all feature points removed and the arbitrary point removed;
computing at least one period matrix, R, for the mesh representation having the arbitrary point removed;
comparing the at least one period matrix, R, corresponding to the mesh representation with at least one standard period matrix corresponding to a standard surface; and
in the event that the period matrix, R, corresponding to the mesh representation and the at least one standard period matrix corresponding to a standard surface are within a predetermined factor of one another, providing indicia that the surface represented by the mesh representation is recognized as being substantially similar to the at least one standard surface.

28. The method of claim 26, wherein the step of doubling the mesh representation, M, includes the steps of:
copying M, denoted as −M;
reversing the orientation of −M;
finding for each boundary vertex u ∈ ∂M, a unique corresponding boundary vertex −u ∈ ∂ −M;
finding for any edge on e ∈ ∂M a unique boundary edge −e ∈ ∂ −M; and
gluing M and −M such that the corresponding vertices and edges are identical, wherein the resulting mesh is the doubling \overline{M}.

29. The method of claim 26, wherein the step of computing the period matrix R includes the steps of:
computing a homology basis {γ₁, γ₂, . . . , γ_{2g}} of said mesh representation, wherein computing said homology basis includes the steps of:
computing a boundary matrix ∂₁, ∂₂ for said mesh representation;
forming a matrix D, wherein D=∂₂∂₂^{T}+∂₁^{T}∂₁;
computing the Smith normal for said matrix D; and
computing the eigenvectors of D corresponding to zero eigenvalues that are equal to {γ₁, γ₂, . . . , γ_{2g}} wherein {γ₁, γ₂, . . . , γ_{2g}} are a homology basis of said mesh representation.

30. The method of claim 26 wherein the step of calculating said period matrix R further includes the step of computing a set of harmonic 1-form basis, wherein the step of computing said set of harmonic 1-form basis includes the steps of:
calculating the value of cᵢ^{j}=−γᵢ*γⱼ, i,j=1, 2, . . . , 2g, wherein γᵢ, γⱼ are the homology basis of the mesh representation; and
solving the linear system δωᵢ=0, Δωᵢ=0, <ωᵢ, γⱼ>=−γᵢ*γⱼ for ωᵢ, wherein {ω₁, ω₂, . . . , ω_{2g}} is the desired harmonic 1-form basis of the mesh representation.

31. The method of claim 29 wherein the step of computing said period matrix R further includes:
calculating the elements of a matrix C as cᵢⱼ=<γᵢ, ωⱼ>;
calculating the elements of a matrix S as sᵢⱼ=<γᵢ, ωⱼ*>; and
calculating the period matrix R as the solution of CR=S where R satisfies R²=−I, where I is the identity matrix.

32. A method for compressing a mesh representation of a surface, the method comprising the steps of:
conformally mapping the mesh representation to a canonical shape;
representing the surface position vector on the canonical shape as a vector valued function;
finding the eigen functions of the Laplacian given by
$$Δω ( u ) = {\sum }_{[ u , v ] ε {K}_{1}} {w}_{[ u , v ]} ω ( [ u , v ] ) ;$$
decomposing the vector valued function using the eigen functions of the Laplacian;
removing the high frequency components of the decomposed vector valued function; and
storing the low frequency components of the decomposed vector valued function as a compressed image of the mesh representation, M, of the surface.

33. The method of claim 31, wherein the surface is a genus-zero surface and the canonical shape is a sphere and wherein the step of conformally mapping the genus-zero surface to the sphere includes the following steps:
a) computing the Gauss map, mapping M to S²;
b) computing the Laplacian at each vertex u of M, Δφ(u);
c) projecting Δφ(u) to the tangent space of φ(u) ∈ S²;
d) updating φ(u) along the negative projected Δφ(u);
e) computing the center of mass of Xφ(u), mc(φ);
f) shifting the center of mass to the center of s²;
g) renormalizing φ(u) to be on S²; and
h) repeating steps b)-g) for all vertices, until the projected Laplacian equals zero.

34. The method of claim 32, wherein the Laplacian is
$$Δ ω ( u ) = {\sum }_{[ u , v ] ∈ {K}_{1}} {w}_{[ u , v ]} ω ( [ u , v ] ) .$$

35. A method for compressing a mesh representation, M, of a surface, the method comprising:
receiving the mesh representation;
conformally mapping mesh representation to a canonical parameter domain forming a mapped surface;
computing a conformal parameterization of said mapped surface;
computing a level set of Gaussian curvature and mean curvature for said mapped surface, wherein said level set of Gaussian curvature and mean curvature is a function of said conformal parameterization; and
storing said conformal parameterization of said mesh representation and said level set corresponding to said mesh representation.

36. The method of claim 34 wherein the step of computing said conformal parameterization includes the step of:
computing a homology basis {γ₁, γ₂, . . . , γ_{2g}} of said mesh representation, wherein computing said homology basis includes the steps of:
computing a set of first and second boundary matrices ∂₁, ∂₂ for said mesh representation;
forming a matrix D, wherein D=∂₂∂₂^{T}+∂₁^{T}∂₁;
computing the Smith normal for said matrix D; and
computing the eigenvectors of D corresponding to zero eigenvalues that are equal to {γ₁, γ₂, . . . , γ_{2g}} wherein {γ₁, γ₂, . . . , γ_{2g}} is a homology basis of said mesh representation.

37. The method of claim 35 wherein the step of computing said conformal parameterization further includes the step of computing a harmonic 1-form basis, wherein the step of computing said harmonic 1-form basis includes the steps of:
calculating the value of cᵢ^{j}=−γᵢ·γⱼ, i,j=1, 2, . . . , 2g wherein γᵢ, γⱼ is the homology basis of the mesh representation respectively; and
solving the linear system δωᵢ=0, Δωᵢ=0, <ωᵢ, ≡ⱼ>=−γᵢ·γⱼ for ωᵢ, wherein {ω₁, ω₂, . . . , ω_{2g}} is the desired harmonic 1-form basis of the mesh representation.

38. The method of claim 36 wherein the step of computing said conformal parameterization further includes the step of computing the fundamental domain D_{M} of the mesh representation, wherein the step of computing the fundamental domain D_{M} of the mesh representation includes the steps of:
selecting an arbitrary face, f₀ ∈ M, and set D_{M to f}₀;
setting ∂Dₘ=∂f₀;
placing all neighboring faces of f₀ that share an edge with f₀ in a queue, Q;
while Q is not empty:
reading the first face in Q;
setting ∂f=e₀+e₁+e₂;
setting D_{M}=D_{M}∪ f;
finding the first eᵢ ∈ ∂f such that −eᵢ ∈ ∂D_{M};
replacing −eᵢ in ∂D_{M}, respectively, by {e₍ᵢ₊₁₎, e₍ᵢ₊₂₎};
putting all the neighboring faces that share an edge with f in the mesh representation and that are not in D_{M} or Q into Q; and
removing all adjacent oriented edges in ∂D_{M} that are opposite each other in sign.

39. A method for remeshing a mesh representation, M, of a surface, the method comprising the steps of:
a) subdividing the mesh, M, using loop subdivision;
b) simplifying the mesh using edge collapse that uses a minimum edge length criteria.
c) repeat steps a) and b) until all angles on the mesh representation, M, are acute; and
d) outputting the remeshed representation, M, of the surface.

40. A method for converting a mesh representation, M, of a surface, the method comprising the steps of:
receiving the mesh representation, M;
computing a conformal representation of the mesh representation, M;
computing the gradient of the mesh representation, M;
computing the zero points of the mesh representation, M;
decomposing the mesh representation, M, into canonical patches using integration lines along the gradient and through the zero points;
conformally mapping the canonical patches onto a respective rectangle;
constructing a tensor product spline surface on the surface of the rectangle; and
matching the control points on the boundary to make the parameterization globally smooth.

41. The method of claim 39 wherein the mesh representation, M, is discontinuous on the boundaries and wherein the parameterization is continuous on the boundaries.

42. A method for conformally mapping a mesh representation of a scanned medical image, M, of a body part to a canonical surface, the method comprising the steps of:
a) computing the Gauss map, mapping M to S²;
b) computing the Laplacian at each vertex u of M, Δφ(u);
c) projecting Δφ(u) to the tangent space of φ(u) ∈ S²;
d) updating φ(u) along the negative projected Δφ(u);
e) computing the center of mass of φ(u), mc(φ);
f) shifting the center of mass to the center of S²;
g) renormalizing φ(u) to be on S²; and
h) repeating steps b)-g) for all vertices, until the projected Laplacian equals zero.

43. A method for animating a mesh representation, M, of a surface from a first mesh representation, M₁, to a second mesh representation, M₂, the method comprising the steps of:
removing at least one feature point common to both M₁ and M₂;
doubling each of M₁ and M₂;
conformally mapping M₁ and M₂ to first and second canonical surfaces, forming first and second mapped surfaces;
computing a holomorphic 1-form for said first and second mapped surfaces;
computing a cohomology basis of said first and second mapped surfaces;
locating first and second zero points on said first and second mapped surfaces;
computing first and second gradients of said first and second mapped surfaces at said first and second zero points, respectively;
decomposing the first and second mesh representations, M₁ and M₂, into first and second sets of canonical patches using integration lines along the first and second gradients and through the first and second zero points, respectively;
conformally mapping the first and second sets of patches onto first and second rectangles, respectively;
matching said first and second mapped patches on said first and second rectangles to form a map therebetween;
selecting at least one control point on each of said first and second mapped patches on said first and second rectangles; and
using a BSpline to generate a smooth transition of said mapping.

44. A method of texture mapping on a mesh representation, M, representative of a surface, the method comprising the steps of:
removing at least one feature point on M;
doubling M;
conformally mapping M to a canonical surface, forming a mapped surface;
computing a holomorphic 1-form for said mapped surface;
computing a cohomology basis of said mapped surface;
locating zero points on said mapped surface;
computing a gradient of said mapped surface;
decomposing said mesh representation, M, into at least two canonical patches using integration lines along said gradient and through said zero point, respectively;
conformally mapping said at least two canonical patches onto at least two rectangles;
growing said at least two rectangles until respective boundaries between said at least two rectangles meet;
fixing the boundaries between said at least two rectangles; and
solving the Dirichlete problem for the uncovered regions of said at least two rectangles.

45. A method of volumetric harmonic mapping of a mesh representation, M, of a 3-dimensional manifold, the method comprising the steps of:
computing the harmonic energy of a mapping f: M→R³, where the harmonic energy is given by
$$E ( f ) = {\sum }_{[ u , v ] ∈ M} {k}_{uv} ‖ f ( u ) - f ( v ) ‖ \qquad and \qquad {k}_{uv} = \frac{1}{48} {\sum }_{θ} cot ( θ ) ,$$
where θ is the dihedral angle opposite to the given edges;
minimizing the harmonic energy using the conjugate gradient method to obtain the harmonic mapping, f.

46. The method of claim 44 wherein the representation M of the 3-dimensional manifold is a magnetic resonance image of a body area of interest, and wherein the mapping f: M→R³ is a map onto a canonical sphere of the body area of interest.

47. The method of claim 45 further including using said map onto said canonical sphere of said body area of interest for surgical planning.
